(19) United States
(12) Patent Application Publication
(10) Pub. No.: US 2025/0296333 A1
(43) Pub. Date: Sep. 25, 2025

(54) LIQUID DISCHARGE HEAD AND LIQUID DISCHARGE APPARATUS

(71) Applicants: Takuma HIRABAYASHI, Tokyo (JP); Keishi MIWA, Kanagawa (JP); Kazuto NAGAHASHI, Kanagawa (JP)

(72) Inventors: Takuma HIRABAYASHI, Tokyo (JP); Keishi MIWA, Kanagawa (JP); Kazuto NAGAHASHI, Kanagawa (JP)

(21) Appl. No.: 19/077,103

(22) Filed: Mar. 12, 2025

(30) Foreign Application Priority Data
Mar. 22, 2024 (JP) 2024-046650
Dec. 12, 2024 (JP) 2024-217576

(51) Int. Cl. B41J 2/14

(52) U.S. Cl. CPC B41J 2/1433; B41J 2/14233; B41J 2002/14306; B41J 2002/14411

(57) ABSTRACT

A liquid discharge head includes a first component and a second component. The first component has a projection projecting in a first direction. The second component is bonded to the first component in a second direction orthogonal to the first direction. The second component has a front peripheral face facing the first component and a side peripheral face intersecting the front peripheral face. The front peripheral face has a groove disposed at a position facing the projection and recessed in a third direction opposite to the second direction. The groove is inside the side peripheral face in a fourth direction opposite to the first direction.

### CROSS-REFERENCE TO RELATED APPLICATIONS

This patent application is based on and claims priority pursuant to 35 U.S.C. § 119(a) to Japanese Patent Application Nos. 2024-046650, filed on Mar. 22, 2024, and 2024-217576, filed on Dec. 12, 2024, in the Japan Patent Office, the entire disclosure of each of which is hereby incorporated by reference herein.

### BACKGROUND

### Technical Field

The present disclosure relates to a liquid discharge head and a liquid discharge apparatus.

### Related Art

In a liquid discharge head, multiple plate-shaped components (substrates) are bonded to one on another with an adhesive.

### SUMMARY

The present disclosure described herein provides an improved liquid discharge head including a first component and a second component. The first component has a projection projecting in a first direction. The second component is bonded to the first component in a second direction orthogonal to the first direction. The second component has a front peripheral face facing the first component and a side peripheral face intersecting the front peripheral face. The front peripheral face has a groove disposed at a position facing the projection and recessed in a third direction opposite to the second direction. The groove is inside the side peripheral face in a fourth direction opposite to the first direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an inkjet image forming apparatus;

FIG. 2 is a block diagram of a control system of the inkjet image forming apparatus of FIG. 1;

FIG. 3 is an exploded perspective view of a liquid discharge head;

FIG. 4 is a cross-sectional view of the liquid discharge head of FIG. 3 taken in a transverse direction;

FIG. 5 is a plan view of a line head unit;

FIG. 6 is a plan view of a serial head unit;

FIG. 7 is a plan view of a liquid discharge head according to a comparative example as viewed from a nozzle face side;

FIG. 8 is a plan view of the liquid discharge head of FIG. 7 from which a nozzle cover is removed, according to the comparative example;

FIG. 9 is a cross-sectional view of a part of the liquid discharge head of FIG. 7 taken along line A1-A1 of FIG. 7, according to the comparative example;

FIG. 10 is a plan view of a liquid discharge head illustrating a nozzle cover cut off from a fixing portion, according to the comparative example;

FIG. 11 is a plan view of a liquid discharge head according to an embodiment of the present disclosure as viewed from a nozzle face side;

FIG. 12 is a plan view of the liquid discharge head of FIG. 11 from which a nozzle cover is removed, according to the present embodiment;

FIG. 13 is a cross-sectional view of a part of the liquid discharge head of FIG. 11 taken along line A2-A2 of FIG. 11, according to the present embodiment;

FIG. 14 is a plan view of a liquid discharge head illustrating a nozzle cover provided with another fixing portion, according to the present embodiment;

FIG. 15 is a cross-sectional view of a part of a liquid discharge head illustrating a hole formed in a base;

FIG. 16 is a cross-sectional view of a part of another liquid discharge head;

FIG. 17 is a schematic diagram of a liquid discharge apparatus;

FIG. 18 is a perspective view of a liquid discharge head and a cover;

FIG. 19 is a cross-sectional view of the liquid discharge head of FIG. 18 taken along plane Ain FIG. 18;

FIG. 20 is a perspective view of substrates of a liquid discharge head laminated one on another in a manufacturing process of the liquid discharge head according to a comparative example;

FIG. 21 is a plan view of substrates connected to gripping portions via connectors which are shifted from each other;

FIG. 22 is a perspective cross-sectional view of a common channel substrate, a first damper frame, and a second damper frame laminated one on another, of the liquid discharge head of FIG. 18;

FIG. 23 is a plan view of a part of the liquid discharge head of FIG. 18, as viewed from the second damper frame side;

FIG. 24 is a front view of a part of the liquid discharge head of FIG. 18, illustrating the common channel substrate, the first damper frame, and the second damper frame laminated one on another, of the liquid discharge head of FIG. 18;

FIG. 25 is a front view of a part of a liquid discharge head in which a projection is bent (curved) into a groove;

FIG. 26 is a plan view of substrates after a first cutting step;

FIG. 27 is a front view of substrates in a second cutting step;

FIG. 28 is a front view of a part of a common channel substrate, illustrating an outer peripheral portion thereof; FIG. 29 is a front view of a part of a common channel substrate, illustrating a projection bent (curved) toward the common channel substrate;

FIG. 30 is a front view of a common channel substrate, illustrating the widths of the common channel substrate and the first damper frame;

FIG. 31 is a plan view of a first groove and a second groove;

FIG. 32 is a cross-sectional view of a part of a liquid discharge head different from the liquid discharge head illustrated in FIG. 18;

FIG. 33 is a perspective cross-sectional view of a common channel substrate, a first damper frame, a second damper frame, and other substrates laminated one on another, of the liquid discharge head of FIG. 32;

FIG. 34 is a plan view of the liquid discharge head of FIG. 32, as viewed from a second damper manifold side;

FIG. 35 is a front view of a part of the liquid discharge head of FIG. 32, illustrating the common channel substrate, the first damper frame, the second damper frame, and other substrates laminated one on another, of the liquid discharge head of FIG. 32;

FIG. 36 is a front view of a liquid discharge head, illustrating the positions of projections;

FIG. 37 is another perspective cross-sectional view of a common channel substrate, a first damper frame, a second damper frame, and other substrates laminated one on another, of a liquid discharge head;

FIG. 38 is still another perspective cross-sectional view of a common channel substrate, a first damper frame, a second damper frame, and other substrates laminated one on another, of a liquid discharge head;

FIG. 39 is a plan view of the liquid discharge head of FIG. 38 as viewed from the second damper manifold side;

FIG. 40 is a front view of a part of the liquid discharge head of FIG. 38, illustrating the common channel substrate, the first damper frame, the second damper frame, and other substrates laminated one on another, of the liquid discharge head of FIG. 38;

FIG. 41 is a perspective cross-sectional view of a common channel substrate, a first damper frame, a second damper frame, and other substrates laminated one on another, of a liquid discharge head according to a comparative example;

FIG. 42 is a plan view of the liquid discharge head of FIG. 41 as viewed from the second damper manifold side, according to the comparative example;

FIG. 43 is a front view of a part of the liquid discharge head of FIG. 41, illustrating the common channel substrate, the first damper frame, the second damper frame, and other substrates laminated one on another, of the liquid discharge head of FIG. 41; and

FIG. 44 is a cross-sectional view of a part of the liquid discharge head of FIG. 11 taken along line A2-A2 of FIG. 11, illustrating a projection having a distorted portion.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the drawings, like reference signs denote like elements, and overlapping descriptions may be simplified or omitted as appropriate. A liquid discharge head that discharges ink as a liquid is described below.

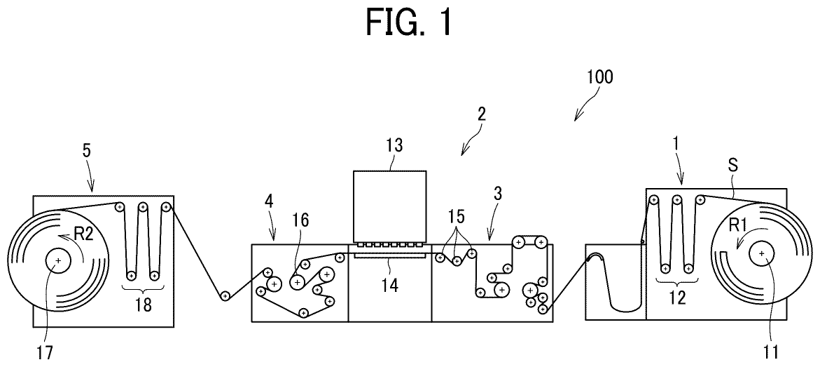

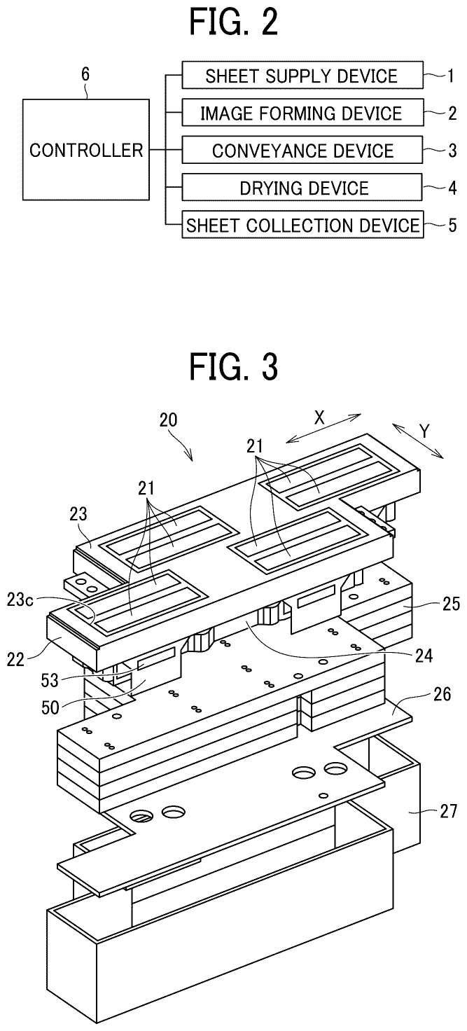

A configuration of an inkjet image forming apparatus, which is a liquid discharge apparatus according to an embodiment of the present disclosure, is described below with reference to FIGS. 1 and 2. FIG. 1 is a diagram illustrating an overall configuration of the inkjet image forming apparatus, and FIG. 2 is a block diagram of a control system of the inkjet image forming apparatus of FIG. 1.

As illustrated in FIG. 1, an image forming apparatus 100 includes a sheet supply device 1 that supplies a sheet S for image formation, an image forming device 2 that forms an image on the sheet S, a conveyance device 3 that conveys the sheet S to the image forming device 2, a drying device 4 that dry the sheet S, and a sheet collection device 5 that collects the sheet S on which an image is formed. The image forming apparatus 100 further includes a controller 6 (see FIG. 2) that controls the sheet supply device 1, the image forming device 2, the conveyance device 3, the drying device 4, and the sheet collection device 5.

The sheet supply device 1 includes a supply roller 11 around which the long sheet S is wound in a roll shape, and a tension adjustment mechanism 12 that adjusts tension applied to the sheet S. The supply roller 11 is rotatable in the direction indicated by arrow R1 illustrated in FIG. 1, and the sheet S is fed from the supply roller 11 as the supply roller 11 rotates. The tension adjustment mechanism 12 includes multiple rollers between which the sheet S is stretched to apply tension to the sheet S. Some of the multiple rollers move to adjust the tension of the sheet S, and the sheet S is fed from the supply roller 11 with a constant tension.

The image forming device 2 includes a head unit 13 as a liquid discharge unit that discharges ink (i.e., a liquid) onto the sheet S, and a platen 14 as a sheet support that supports the sheet S being conveyed. The head unit 13 includes multiple liquid discharge heads. Each of the multiple liquid discharge heads discharges ink onto the sheet S based on image data generated by the controller 6 to form an image on the sheet S. The ink is a liquid containing a colorant, a solvent, and crystalline resin particles dispersed in the solvent. The crystalline resin changes a phase thereof and melts from a crystal to a liquid when heated above a melting point thereof. The platen 14 faces the head unit 13 and supports the lower surface (back surface) of the sheet S supplied from the sheet supply device 1. The platen 14 approaches and separates from the head unit 13 so as to keep the distance between the head unit 13 and the sheet S constant.

The conveyance device 3 as a conveyor includes a plurality of conveyance rollers 15. The sheet S is conveyed to the image forming device 2 by the rotation of the conveyance rollers 15 while being stretched between the conveyance rollers 15. The conveyance device 3 may include other conveyors such as a conveyance belt.

The drying device 4 includes a heating drum 16 that heats the sheet S to dry ink on the sheet S. The heating drum 16 has a cylindrical shape and rotates while the sheet S is wound around the outer circumferential surface thereof, and a heating source such as a halogen heater is disposed inside the heating drum 16. A non-contact heating unit such as a hot air generating device that blows hot air to the sheet S can be used as a heating unit to heat the sheet S in addition to a contact heating unit such as the heating drum 16.

The sheet collection device 5 includes a collection roller 17 that winds and collects the sheet S, and a tension adjustment mechanism 18 that adjusts tension applied to the sheet S. The collection roller 17 is rotatable in the direction indicated by arrow R2 illustrated in FIG. 1, and the sheet S is wound in a roll shape around the collection roller 17 as the collection roller 17 rotates. The tension adjustment mechanism 18 includes multiple rollers, similarly to the tension adjustment mechanism 12 of the sheet supply device 1. Some of the multiple rollers move to adjust the tension of the sheet S, and the sheet S is wound up by the collection roller 17 with a constant tension.

The controller 6 includes an information processor such as a personal computer (PC). The controller 6 generates the image data to be formed on the sheet S, and controls various operations of the sheet supply device 1, the image forming device 2, the conveyance device 3, the drying device 4, and the sheet collection device 5. For example, the controller 6 controls the temperatures of the heating source that heats the heating drum 16 in addition to the rotation speeds of the supply roller 11, the collection roller 17, and the conveyance rollers 15.

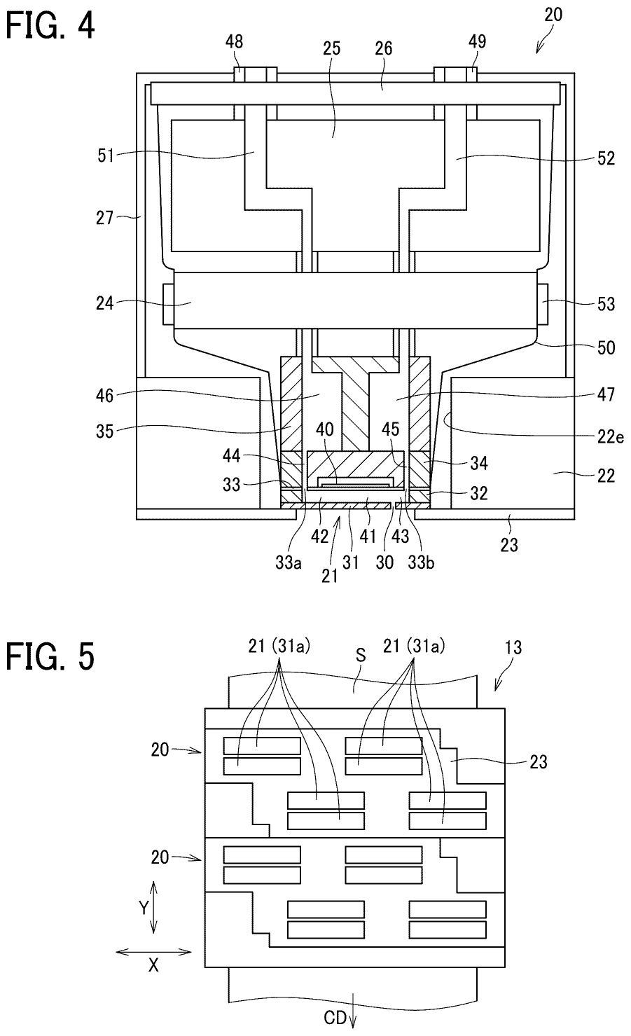

The configuration of the liquid discharge head is described below with reference to FIGS. 3 and 4.

FIG. 3 is an exploded perspective view of the liquid discharge head, and FIG. 4 is a cross-sectional view of the liquid discharge head illustrated in FIG. 3 in a transverse direction of the liquid discharge head (a direction Y indicated by arrow Y in FIG. 3).

As illustrated in FIG. 3, a liquid discharge head 20 includes multiple head bodies 21, a base 22 as a nozzle-side bonded component, a nozzle cover 23, a heat dissipator 24, a manifold 25, a printed circuit board (PCB) 26, and a head case 27.

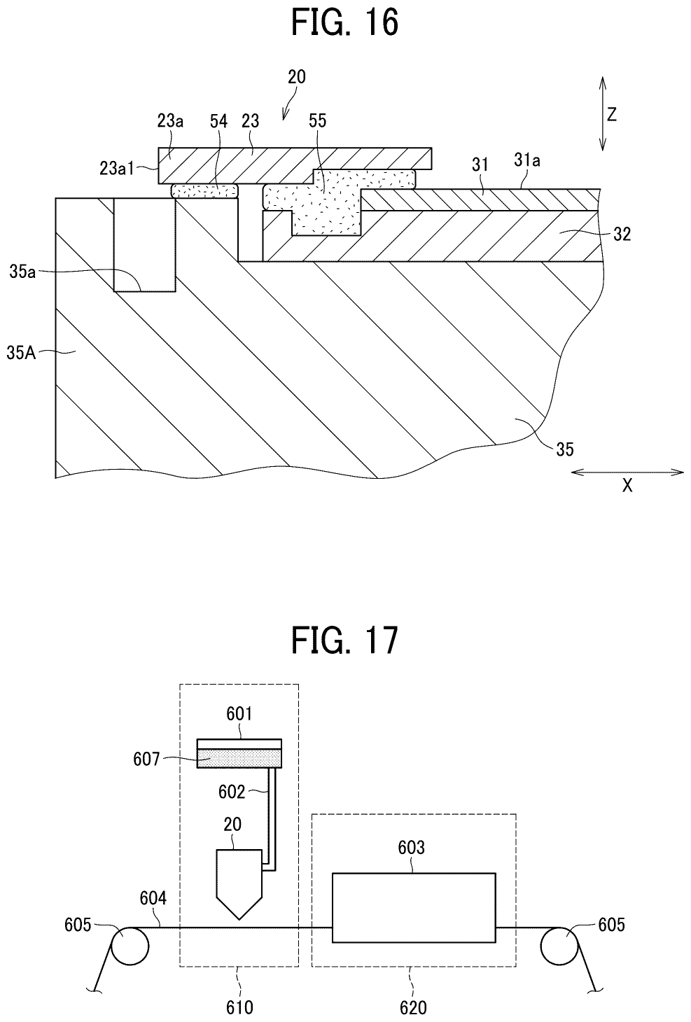

In the present embodiment, the liquid discharge head 20 includes the multiple head bodies 21, but a liquid discharge head of an embodiment of the present disclosure is not limited thereto. A liquid discharge head of an embodiment of the present disclosure may include at least one head body, a nozzle cover that covers and protects the head body, and a nozzle-side bonded component that is bonded to the nozzle cover. Alternatively, the nozzle-side bonded component may construct a portion of the head body (see FIG. 16 which will be described later).

The base 22 holds the multiple head bodies 21. The base 22 is a component having an outer peripheral face of the liquid discharge head 20. In order to attach the head body 21 to the base 22, first, the head body 21 is inserted into an opening 22e (see FIG. 4) formed in the base 22. Then, the head body 21 is bonded to the nozzle cover 23 bonded to the base 22. The nozzle cover 23 has a hole 23c (see FIG. 3) corresponding to the head body 21, and a peripheral area of the head body 21 is bonded to an inner edge of the hole 23c. The head body 21 is fixed to the base 22 with screws. Specifically, a common channel substrate 35 (refer to FIG. 4) has flanges on the front side and the back side in the longitudinal direction (direction orthogonal to the surface of the paper on which FIG. 4 is drawn) of the head body 21, and the flanges are fastened to the base 22 with screws. Thus, the base 22 holds the common channel substrate 35 to fix the head body 21. The structure for attaching the head body 21 to the base 22 is not limited to the above structure, and the head body 21 may be attached by, for example, adhesion, caulking, swaging, or riveting.

As illustrated in FIG. 4, the head body 21 includes a nozzle plate 31 as a nozzle component having nozzles 30, a channel substrate 32 defining individual liquid chambers 41 communicating with the nozzles 30, a diaphragm 33 including a piezoelectric element 40, a holding substrate 34 laminated on the diaphragm 33, and the common channel substrate 35 as a frame laminated on the holding substrate 34.

In addition to the individual liquid chambers 41, the channel substrate 32 defines supply-side individual channels 42 communicating with the individual liquid chambers 41 and collection-side individual channels 43 communicating with the individual liquid chambers 41, respectively. The holding substrate 34 defines supply-side intermediate individual channels 44 and collection-side intermediate individual channels 45. The supply-side intermediate individual channels 44 communicate with the supply-side individual channels 42 via openings 33a of the diaphragm 33, respectively. The collection-side intermediate individual channels 45 communicate with the collection-side individual channels 43 via openings 33b of the diaphragm 33, respectively.

The common channel substrate 35 (i.e., the frame) defines a supply-side common channel 46 and a collection-side common channel 47. The supply-side common channel 46 communicates with the supply-side intermediate individual channels 44. The collection-side common channel 47 communicates with the collection-side intermediate individual channels 45. The supply-side common channel 46 communicates with a supply port 48 via a channel 51 of the manifold 25. The collection-side common channel 47 communicates with a collection port 49 via a channel 52 of the manifold 25.

The PCB 26 and the piezoelectric element 40 of the head body 21 are connected via a flexible wiring board 50. A driver integrated circuit (IC) 53 is mounted on the flexible wiring board 50.

The base 22 is preferably made of a material having a small linear expansion coefficient. Examples of the material having a small linear expansion coefficient include 42Alloy which is an alloy of iron with nickel and an invar material. With the base 22 made of such a material, even when the temperature of the base 22 is increased by heat generated by the liquid discharge head 20, the amount of expansion of the base 22 is small, and thus the positional deviation of the nozzles is unlikely to occur. As a result, the positional deviation of the discharged ink can be reduced. Further, by forming the nozzle plate 31 and the diaphragm 33 from a silicon single crystal substrate and setting the linear expansion coefficient of the nozzle plate 31 and the diaphragm 33 to be substantially the same as that of the base 22, the positional deviation of the nozzles due to thermal expansion can be reduced.

FIG. 5 is a plan view of a head unit. As illustrated in FIG. 5, the head unit 13 includes two liquid discharge heads 20. The transverse direction (i.e., the direction Y indicated by arrow Y) of each liquid discharge head 20 is aligned with a conveyance direction CD of the sheet S, and the longitudinal direction (the direction indicated by arrow X) of each liquid discharge head 20 is aligned with a direction orthogonal to the conveyance direction CD. As illustrated in FIG. 5, the “longitudinal direction” of the liquid discharge head 20 means the longitudinal direction (direction X indicated by arrow X) in which the liquid discharge head 20 extends in one direction when viewed in a direction orthogonal to a nozzle face 31a on which the nozzles 30 (see FIG. 4) are exposed. The “transverse direction” of the liquid discharge head 20 means a direction (direction Y indicated by arrow Y) orthogonal to the longitudinal direction of the liquid discharge head 20 when viewed in the direction orthogonal to the nozzle face 31a. The “longitudinal direction” and the “transverse direction” of the liquid discharge head 20 described in the following description have the same meaning.

The head unit 13 illustrated in FIG. 5 is a so-called line head unit. When the sheet S is conveyed to a position facing the head unit 13, the head unit 13 does not move and discharges ink from the nozzles 30 of the head bodies 21 to the sheet S being conveyed to form an image on the sheet S.

In addition to the line head unit, a so-called serial head unit that discharges ink while moving the liquid discharge head in a main scanning direction (i.e., a width direction of the sheet S) can be used.

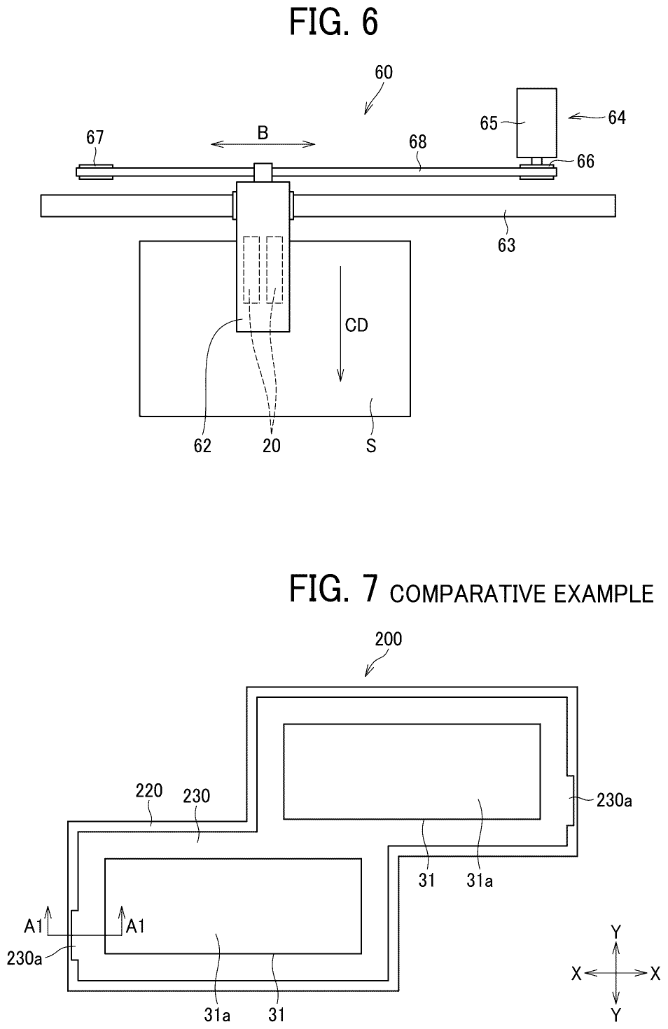

FIG. 6 is a plan view of a serial head unit 60. As illustrated in FIG. 6, the serial head unit 60 includes a carriage 62 on which liquid discharge heads 20 are mounted, a guide (guide rod) 63 that guides the carriage 62 in the main scanning direction, which is the width direction of the sheet S indicated by arrow B, and a driver 64 that moves the carriage 62.

The driver 64 includes a motor 65 serving as a driving source and a timing belt 68 looped around a drive pulley 66 and a driven pulley 67. As the motor 65 is driven and the drive pulley 66 is rotated, the timing belt 68 circumferentially moves. Accordingly, the carriage 62 is moved in the main scanning direction along the guide 63. As the rotation direction of the motor 65 is switched between one direction and the opposite direction, the carriage 62 reciprocates in the main scanning direction.

In the serial head unit 60, the liquid discharge heads 20 discharge ink in response to image signals while the carriage 62 moves in the main scanning direction. By so doing, an image for one line is formed on the sheet P not in motion. The reciprocal movement of the carriage 62 and the discharge of the ink are repeatedly performed while the sheet S is intermittently moved by a predetermined amount in the conveyance direction of the sheet S indicated by arrow CD in FIG. 6. By so doing, an image is sequentially formed on the sheet S.

### Bonding Configuration of Nozzle Cover

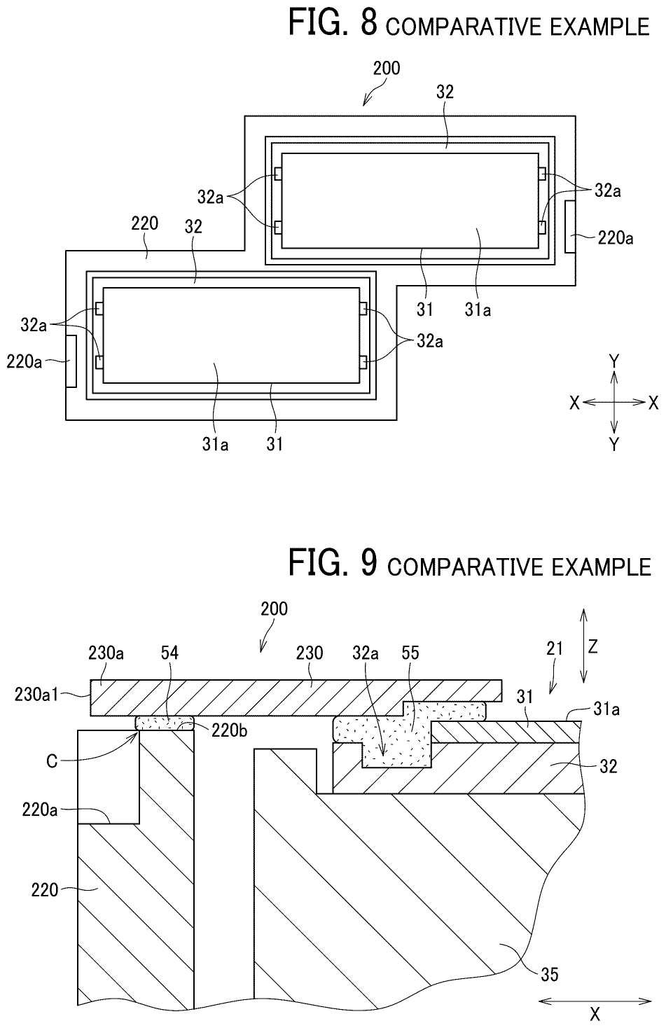

A structure for bonding the nozzle cover to the base will be described below using a liquid discharge head 200 of FIGS. 7 to 9, according to a comparative example. The liquid discharge head 200 has a base 220 and a nozzle cover 230 which are different from those of the present embodiment. Although eight head bodies are mounted on the liquid discharge head in FIG. 3, a liquid discharge head having two head bodies will be described in the following description. FIG. 7 is a plan view of a liquid discharge head as viewed from a nozzle face side. FIG. 8 is a plan view of the liquid discharge head of FIG. 7, from which a nozzle cover is removed. FIG. 9 is a cross-sectional view of a part of the liquid discharge head of FIG. 7 taken along line A1-A1 of FIG. 7. The direction Z in FIG. 9 is a bonding direction in which the base and the nozzle cover are overlaid on and bonded to each other, or a thickness direction of the nozzle cover. The direction Z is also a liquid discharge direction (i.e., a second direction) from the nozzles and a direction (i.e., a third direction) opposite to the liquid discharge direction. In FIGS. 7 and 8, the direction Z is orthogonal to the surface of the paper on which FIGS. 7 and 8 are drawn.

The nozzle cover 230 covers at least a part of the nozzle face 31a except for the nozzles. In this comparative example, the nozzle cover 230 covers the edge of the nozzle face 31a and the vicinity thereof. The nozzle cover 230 has a projection 230a on the outer edge thereof. The projection 230a projects outward further than the other portions of the outer edge. In other words, the projection defines a part of the outer edge and projects from the other portions (i.e., a surrounding outer edge) in the direction X (i.e., a first direction).

As illustrated in FIG. 8, the base 220 has a recess 220a at a position facing the projection 230a of the nozzle cover 230. The recess 220a is open outward on the outer peripheral face of the base 220 in the direction X. The recess 220a is recessed in a direction (i.e., the fourth direction) away from the nozzle cover 230 in the direction Z (a far side of the surface of the paper on which FIG. 8 is drawn) with respect to the peripheral portion of the recess 220a.

The center side (right side in FIG. 9) of the nozzle face 31a is referred to as the “inner side or inside” and the opposite side (left side in FIG. 9) is referred to as the “outer side or outside.” As illustrated in FIG. 9, an outer portion of the nozzle cover 230 on the outer side is bonded to the base 220 via an adhesive 54. The base 220 is disposed around the nozzle plate 31, the channel substrate 32, and the common channel substrate 35, and the outer portion of the nozzle cover 230 on the outer side is bonded to a surface 220b (i.e., a front peripheral face facing the nozzle cover 230) of the base 220 facing the nozzle cover 230 in the liquid discharge direction (i.e., the direction Z).

On the other hand, an inner portion of the nozzle cover 230 on the inner side is bonded to the nozzle plate 31 and the channel substrate 32 via an adhesive 55. The channel substrate 32 is disposed on a face of the nozzle plate 31 (i.e., the lower face of the nozzle plate 31 in FIG. 9) opposite the nozzle face 31a, and a portion of the channel substrate 32 projects outward from the edge of the nozzle plate 31. The nozzle cover 230 is bonded to the portion of the channel substrate 32 projecting outward and the edge of the nozzle plate 31.

As described above, both the outer portion and the inner portion of the nozzle cover 230 are respectively bonded to the corresponding components (i.e., the base 220, and the nozzle plate 31 and the channel substrate 32) via the adhesive 54 and the adhesive 55, and the gap between the components and the nozzle cover 230 is sealed by the adhesives 54 and 55. Accordingly, ink and other foreign substances are prevented from entering the inside from the gap.

A recess 32a is formed in a bonded portion of the channel substrate 32 bonded to the nozzle cover 230. The bonded portion of the channel substrate 32 projects outward from the nozzle plate 31 in the direction X. Multiple recesses 32a are disposed on both sides of the channel substrate 32 in the longitudinal direction (see FIG. 8). Thus, the adhesive 55 is poured into the recess 32a to increase the bonding strength between the nozzle cover 230 and the channel substrate 32.

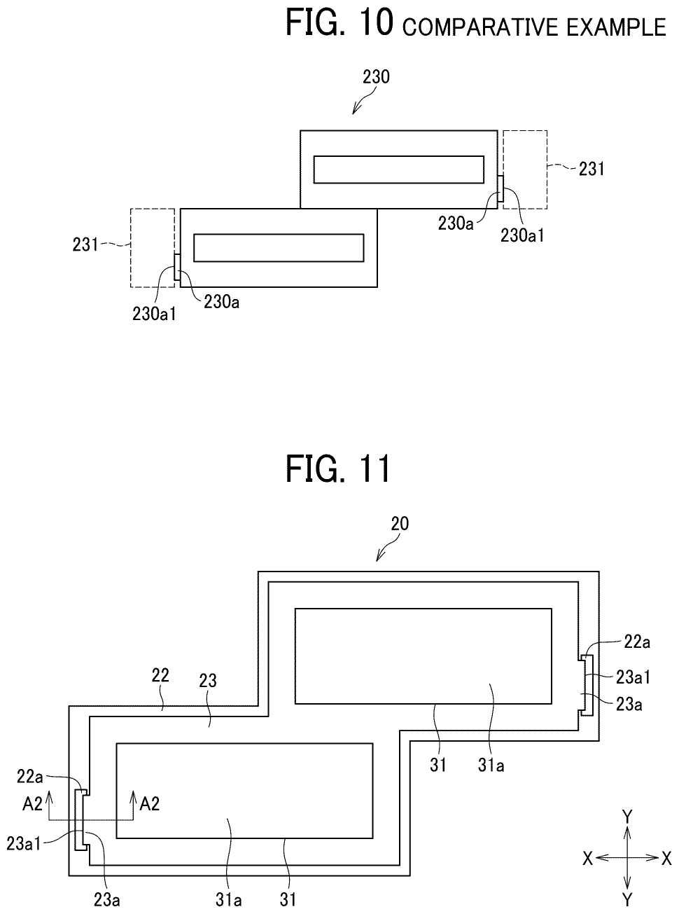

The nozzle cover 230 is formed of a metal plate. The projection 230a formed in the nozzle cover 230 is a portion including an end face 230al (i.e., a cut surface) formed in a cutting step for forming the nozzle cover 230 and the peripheral portion thereof. Specifically, as illustrated in FIG. 10, the nozzle cover 230 during manufacturing has fixing portions 231 at both ends thereof. The fixing portions 231 are portions for fixing the nozzle cover 230 to equipment, for example, in a film forming step during manufacturing. The fixing portions 231 are finally cut out from the nozzle cover 230. Thus, the projection 230a including the end face 230al, which is the cut surface, remains in the finished nozzle cover 230. In the following description, the similar cutting step, which forms a projection as described above, applies to a nozzle cover 23, for example, illustrated in FIG. 11. As illustrated in FIG. 10, the body of the nozzle cover 230 and the fixing portions 231 are partially connected by the projection 230a. Accordingly, the cut surface finally remaining in the nozzle cover 230 can be limited to a small area.

As described above, the end face 230a1 of the projection 230a of the nozzle cover 230 is the cut surface. For example, burrs or shape distortions may be generated in the peripheral portion of the projection 230a including the end face 230al in the cutting step. As illustrated in FIG. 9, the flat face of the nozzle cover 230 and the flat face of the base 220 are bonded to each other. If the projection 230a of the nozzle cover 230 is bonded to the base 220, the shape distortions may hinder the desired bonding between the nozzle cover 230 and the base 220. When this portion (the projection 230a) is bonded to the base 220, the overall bonding quality between the nozzle cover 230 and the base 220 is adversely affected.

In the liquid discharge head 200 of FIG. 9, the recess 220a is formed at a position overlapping the projection 230a, and thus the projection 230a is not bonded to the base 220. Such a configuration can enhance the bonding quality between the base 220 and the nozzle cover 230.

However, on the other hand, the projection 230a is not bonded to the base 220 and faces the recess 220a. As a result, the strength of the projection 230a may be weakened. In addition, in the liquid discharge head 200 illustrated in FIG. 9, the recess 220a is open outward in the longitudinal direction of the liquid discharge head 200 (direction X), and thus, for example, a foreign substance such as a sheet is likely to contact the end face 230al of the projection 230a from the left side of FIG. 9. For these reasons, the nozzle cover 230 may peel off from a bonded portion C facing the recess 220a at the bonded portion C between the base 220 and the nozzle cover 230 due to the impact of the foreign substance. This may cause ink to enter the inside of the liquid discharge head.

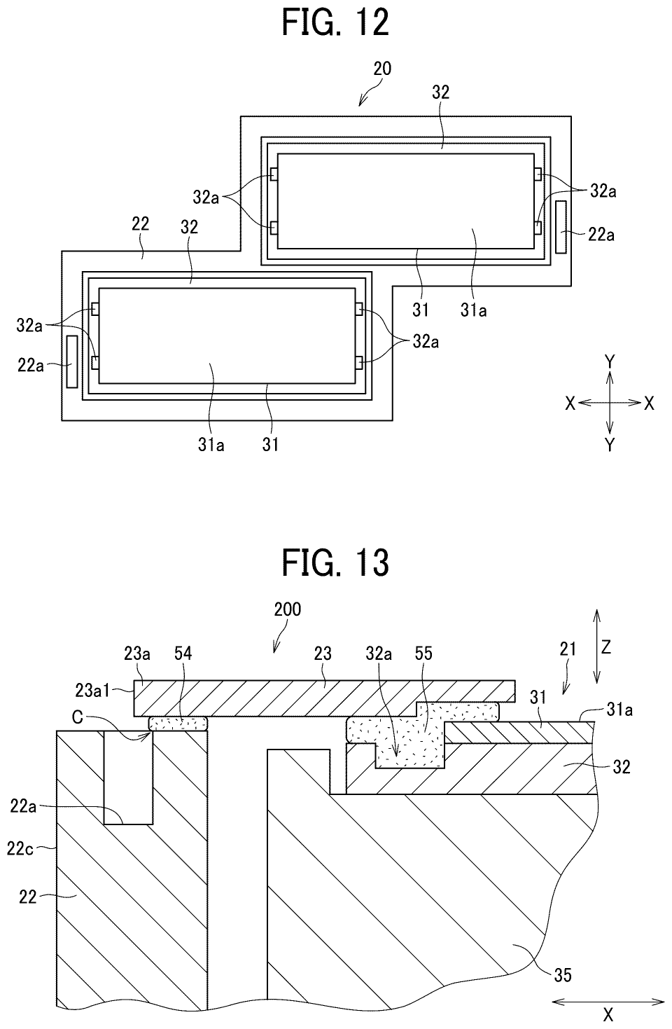

A liquid discharge head according to the present embodiment is described below with reference to FIGS. 11 to 13. FIG. 11 is a plan view of a liquid discharge head as viewed from a nozzle face side. FIG. 12 is a plan view of the liquid discharge head of FIG. 11, from which a nozzle cover is removed. FIG. 13 is a cross-sectional view of a part of the liquid discharge head of FIG. 11 taken along line A2-A2 of FIG. 11. In the following description, differences from the liquid discharge head 200 of FIGS. 7 to 9 will be described, and descriptions of common points will be appropriately omitted. The liquid discharge head 20 is different from the liquid discharge head 200 in the configurations of the base 22 and the nozzle cover 23, and the other configurations are common.

As illustrated in FIGS. 11 to 13, the base 22 of the liquid discharge head 20 has a recess 22a. The recess 22a is recessed in a direction (i.e., the fourth direction) away from the nozzle cover 23 in the direction Z. The recess 22a is different from the recess 220a of the base 220 described above in that the recess 22a does not face the outer peripheral face (i.e., a side peripheral face facing the nozzle cover 23) of the base 22 in the direction X, does not face the outer peripheral face (i.e., an outer side face) of the base 22 in the direction Y, and is disposed inside the base 22. In other words, the recess 22a does not define the outer peripheral face in either the direction X or the direction Y as viewed in the direction Z and is disposed inside the base 22. The direction Z is orthogonal to the surface of the paper on which FIG. 11 is drawn.

In the present embodiment, the nozzle cover 23 (i.e., a first component) has a projection 23a corresponding to the projection 230a illustrated in FIG. 9. The recess 22a is disposed at a position facing the projection 23a of the nozzle cover 23. The phrase “recess 22a is disposed at a position facing the projection 23a” means that the projection 23a and the recess 22a overlap each other when viewed in the direction Z which is the direction orthogonal to the surface of the paper on which FIG. 11 is drawn. At least a part of the recess 22a is disposed at the position facing at least a part of the projection 23a. Such a configuration can enhance the bonding quality of the nozzle cover 23 to the base 22 as described above.

In the present embodiment, as illustrated in FIG. 13, the recess 22a is disposed inside the base 22. In other words, the recess 22a is disposed away from the outer peripheral face of the base (i.e., a second component) inward in the fourth direction opposite to the first direction. In other words, a portion including an outer peripheral face 22c (i.e., a side peripheral face intersecting the front peripheral face) of the base 22 is disposed outside the projection 23a of the nozzle cover 23. For example, even when a foreign substance such as a sheet collides with the liquid discharge head 200 from the left side of FIG. 13, such a configuration can prevent the foreign substance from contacting an end face 23a1 of the projection 23a. Thus, such a configuration can prevent the nozzle cover 23 from peeling off from the base 22 at the bonded portion C between the nozzle cover 23 and the base 22, which faces the recess 22a.

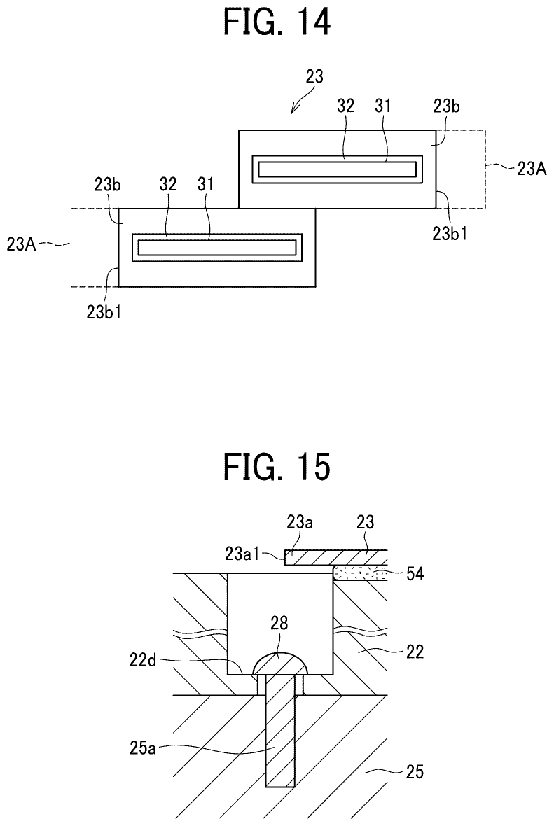

In the above description, the projection 23a partially projecting from the peripheral portion of the nozzle cover 23 is formed on the nozzle cover 23, but an embodiment of the present disclosure is not limited thereto. For example, as illustrated in FIG. 14, fixing portions 23A may be cut along the entire end face of the nozzle cover 23 in the left-right direction in FIG. 14. In this case, an entire end face 23b1 is a cut surface when the fixing portion 23A is cut out from the nozzle cover 23. The recess 22a of the base 22 is formed so as to face a distorted portion 23b including the end face 23b1. A distorted portion formed in the nozzle cover is a portion partially distorted in shape from the peripheral portion. Examples of the distorted portion include a portion of a burr formed by cutting, a portion partially projecting toward the base (i.e., the nozzle-side bonded component) due to the warpage of the end of the nozzle cover, a portion warped toward the side opposite to the base (i.e., the nozzle-side bonded component), or a portion having larger unevenness than the peripheral portion. For example, in the nozzle cover 23, the distorted portion 23b is formed with a warp near the end face 23b1 or a burr on the end face 23b1 by cutting, and the shape of the distorted portion 23b is partially changed with respect to the peripheral flat portion formed of the plate material. The distorted portion 23b includes at least the end face 23b1. The distorted portion 23b is a portion including the cut surface and the vicinity thereof. The distorted portion 23b is also a part (or may be the whole) of a portion of the nozzle cover 23 closer to the end face 23b1 than the channel substrate 32 or the nozzle plate 31, including the end face 23b1. In other words, the projection 23a having the end face 23a1 (i.e., the cut surface) may have a distorted portion such as a burr 23r illustrated FIG. 44. At least a part or all of the recess 22a (or a through hole) may be formed at a position facing a part or all of the distorted portion 23b. The recess 22a is formed at a position facing at least the cut surface of the nozzle cover. Such a configuration can enhance the bonding quality between the nozzle cover and the base. As illustrated in FIG. 13, the recess 22a (or the through hole) facing the distorted portion is formed inside the base 22. Such a configuration can prevent the nozzle cover 23 from peeling off from the base 22. A projection or a distorted portion may be formed on the end face of the nozzle cover 23 in the vertical direction in FIG. 14. The distorted portion may not be formed by cutting.

In the above embodiment, as illustrated in FIG. 11, one recess 22a is provided for each head body 21 (i.e., two recesses 22a in total), but the number and the size of recesses are not limited thereto. For example, the recess 22a may be formed so as to face the entire end face 23b1 illustrated in FIG. 14, or multiple recesses 22a may be formed so as to face the end face 23b1.

In the above description, the recess is formed at the position corresponding to the projection or the distorted portion of the base, but a through hole may be formed instead of the recess. As illustrated in FIG. 15, a through hole 22d may be formed in the base 22, and the through hole 22d may be a screw hole to fasten the base 22 to another component. The through hole 22d has a small-diameter portion as the screw hole into which a screw 28 is inserted. In FIG. 15, the screw 28 is screwed into a fastening hole 25a of the manifold 25 through the through hole 22d to fix the base 22 to the manifold 25.

The recess 22a or the through hole 22d formed in the base 22 may be filled with an adhesive (see FIG. 44). By so doing, the base 22 and the projection 23a of the nozzle cover 23 can be bonded to each other with the adhesive. In this case, since the projection 23a is bonded to the adhesive filled in the recess 22a of the base 22, the shape distortion of the projection 23a can be absorbed in the recess 22a so as not to adversely affect the overall bonding quality between the nozzle cover 23 and the base 22. Accordingly, the bonding strength of the nozzle cover to the base can be further enhanced. In the present embodiment, the recess 22a or the through hole 22d is disposed inside the base 22 to prevent the adhesive 54 filled in the recess 22a or the through hole 22d from leaking to the outside. Due to such a configuration, the base 22 and the projection 23a of the nozzle cover 23 can be bonded to each other without the leaking of the adhesive 54. To fill the adhesive in the recess 22a or the through hole 22d, for example, the amount of the adhesive 54 may be increased, or the pressure for pressing the nozzle cover 23 against the base 22 may be increased when bonding the nozzle cover 23 to the base 22.

In the embodiment illustrated in FIG. 16, the base 22 (see FIG. 13) is not provided. Instead of the base 22, the common channel substrate 35 (i.e., the frame) as a nozzle-side bonded component serves as a frame portion of the head body and a frame portion of the liquid discharge head. The nozzle cover 23 is bonded to the common channel substrate 35. Specifically, the common channel substrate 35 has an outer peripheral portion 35A disposed around (outside) the nozzle plate 31 and the channel substrate 32. The outer peripheral portion 35A is a portion corresponding to the base of the above-described embodiment. A recess 35a is formed inside the outer peripheral portion 35A of the common channel substrate 35 and does not face the outside of the common channel substrate 35. The recess 35a faces the projection 23a of the nozzle cover 23.

In the present embodiment, the recess 35a is disposed inside the common channel substrate 35 and does not face the outside (i.e., the side peripheral face) of the common channel substrate 35. Thus, the nozzle cover 23 can be prevented from peeling off from the common channel substrate 35.

### Bonding Configuration of Laminated Substrates

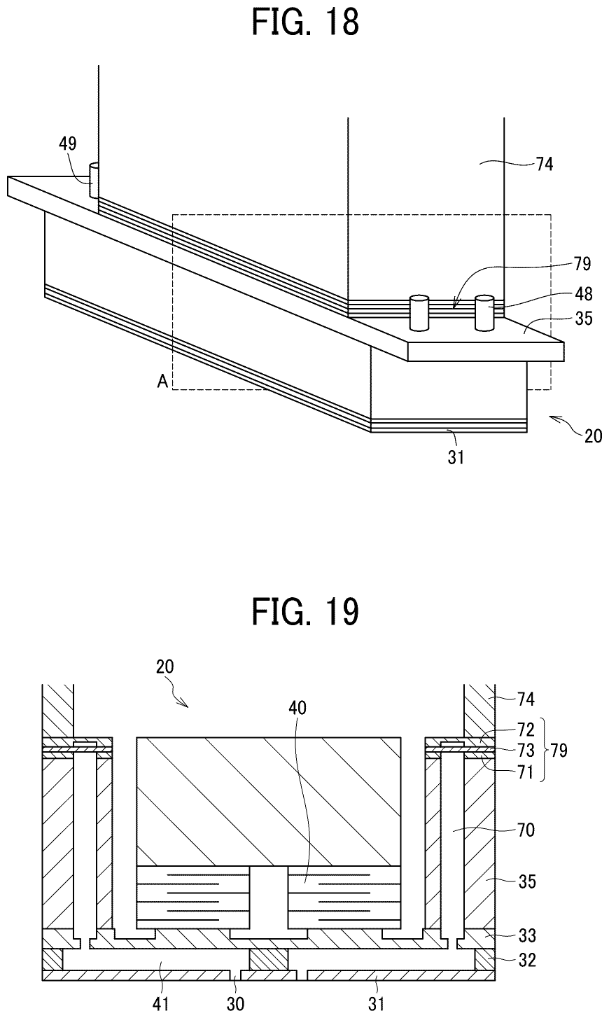

A bonding configuration in the common channel substrate on the side opposite the nozzle cover of the liquid discharge head will be described below with reference to FIGS. 18 and 19 illustrating a liquid discharge head according to another embodiment of the present disclosure. FIG. 18 is a perspective view of a liquid discharge head and a cover. FIG. 19 is a cross-sectional view of the liquid discharge head of FIG. 18 taken along plane Ain FIG. 18.

As illustrated in FIG. 18, a cover 74 covers one side of the liquid discharge head 20 opposite the nozzle plate 31. As illustrated in FIG. 19, the liquid discharge head 20 includes the nozzle plate 31, the channel substrate 32, the diaphragm 33, the piezoelectric element 40, and the common channel substrate 35 as a first bonding component (i.e., the second component), similarly to the above-described embodiment. The liquid discharge head 20 further includes a first damper frame 71 as a first substrate, a second damper frame 72 as a second substrate, and a damper 73, which are laminated one on another and bonded to each other in the vertical direction in FIG. 19 to form laminated substrates 79 (i.e., the first component). A common channel 70 is formed in the common channel substrate 35.

The damper 73 has flexibility. The damper 73 is sandwiched between the first damper frame 71 and the second damper frame 72. The first damper frame 71 holds one side of the damper 73 below which the nozzle plate 31 having the nozzle 30 is disposed in FIG. 19. The second damper frame 72 holds the other side of the damper 73 opposite the one side below which the nozzle plate 31 having the nozzle 30 is disposed.

The shapes of the channels of the channel substrate 32, the first damper frame 71, and the second damper frame 72 can be formed by, for example, etching a substrate made of steel use stainless (SUS) with an acidic etching solution or machining such as punching.

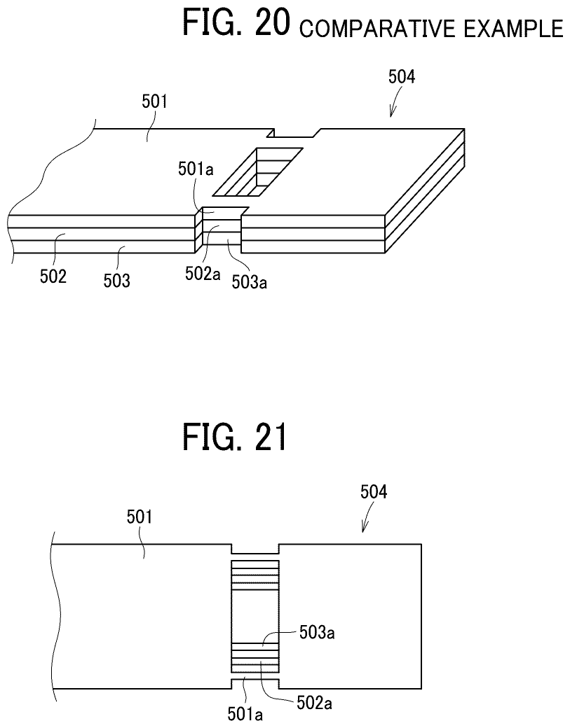

FIG. 20 is a perspective view of a liquid discharge head illustrating substrates laminated one on another in a manufacturing process of the liquid discharge head according to a comparative example.

As illustrated in FIG. 20, substrates 501, 502, and 503 formed of SUS are laminated one on another to form laminated substrates. These substrates 501, 502, and 503 correspond to, for example, the above-described damper frames. The substrates 501, 502, and 503 are provided with gripping portions 504 on both sides in the longitudinal direction via connectors 501a, 502a, and 503a.

The gripping portion 504 is a gripping portion for holding these substrates when performing each operation such as bonding of these substrates in the manufacturing process of the liquid discharge head. Accordingly, since the gripping portion 504 is an unnecessary portion as a final product, the gripping portion 504 is cut off from the substrates 501, 502, and 503 by cutting the connectors 501a, 502a, and 503a in the manufacturing process.

However, when the connectors 501a, 502a, and 503a overlap each other as illustrated in FIG. 20, the connectors 501a, 502a, and 503a are thick and difficult to cut. Preferably, as illustrated in FIG. 21, the connectors 501a, 502a, and 503a are shifted from each other. In the present embodiment, the connectors are shifted from each other.

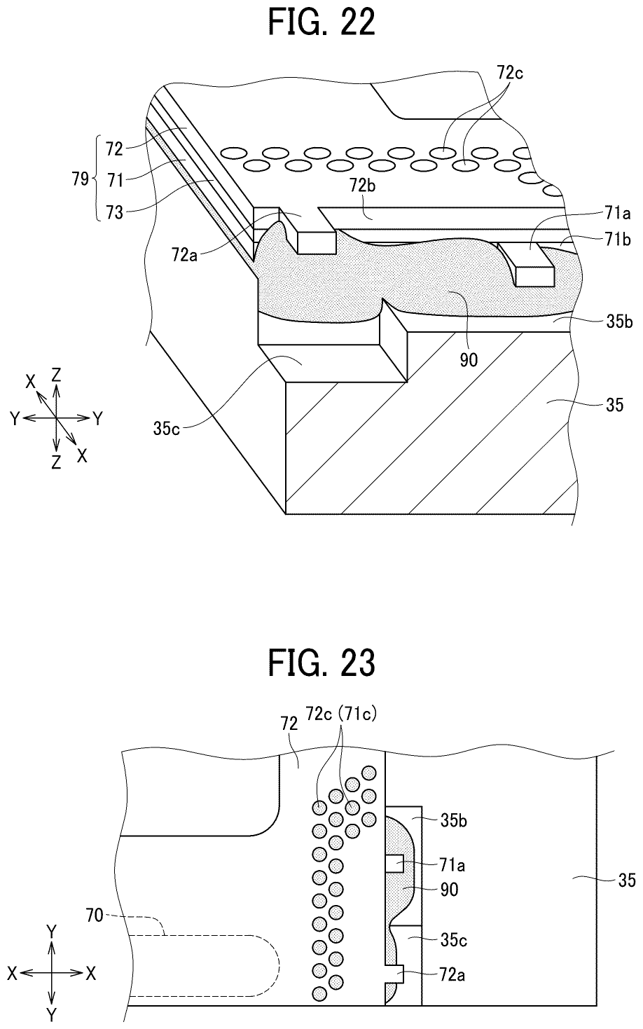

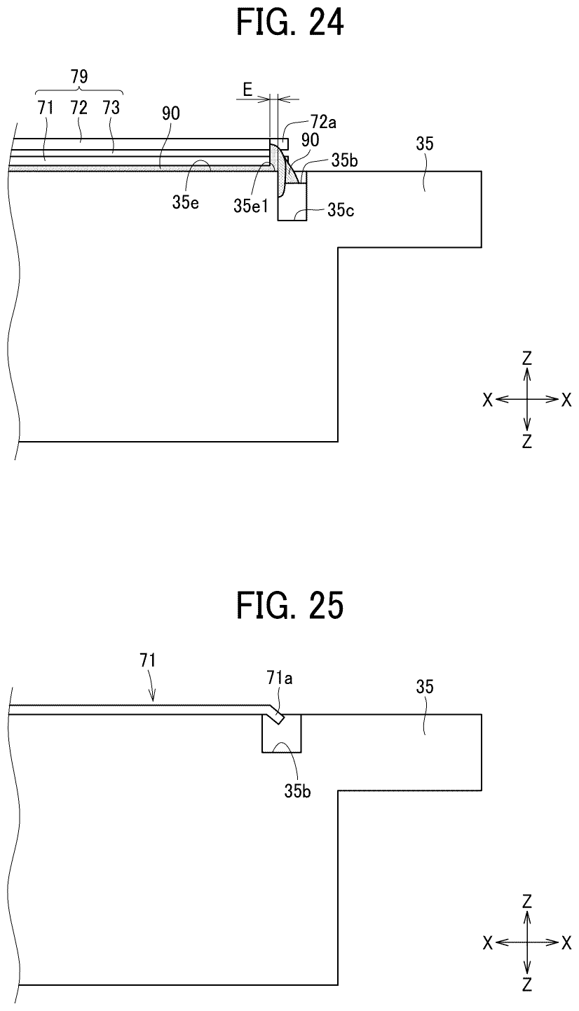

FIG. 22 is a perspective cross-sectional view of the common channel substrate, the first damper frame, and the second damper frame laminated one on another according to the present embodiment. FIG. 22 illustrates one end in the longitudinal direction where the connectors are disposed. FIG. 23 is a plan view thereof, and FIG. 24 is a front view thereof.

As illustrated in FIG. 22, the first damper frame 71 has a lower projection 71a as a first projection, and the second damper frame 72 has an upper projection 72a as a second projection.

The direction X in FIG. 22 is the projecting direction of the lower projection 71a and the upper projection 72a. However, an embodiment of the present disclosure is not necessarily limited to the lower projection 71a and the upper projection 72a extending in the direction X. The direction X is the longitudinal direction of the first damper frame 71 and the common channel substrate 35. The direction Y is the transverse direction of the first damper frame 71 and the common channel substrate 35. The direction Z is the lamination direction (i.e., a bonding direction) of the respective substrates of the laminated substrates 79 and the common channel substrate 35. The directions X, Y, and Z are orthogonal to each other.

The lower projection 71a and the upper projection 72a are shifted from each other in the direction Y, and do not overlap each other when viewed in the lamination direction. The upper projection 72a is closer to the outer side face of the common channel substrate 35 than the lower projection 71a in the direction Y (i.e., a fifth direction). The lower projection 71a and the upper projection 72a are the connectors connecting the gripping portion and the substrates such as the first and second damper frames 71 and 72 as described above in the manufacturing process of the liquid discharge head. The lower projection 71a and the upper projection 72a have cut surfaces on the end faces thereof in the liquid discharge head.

In the present embodiment, the projections of the laminated substrates 79 are the lower projection 71a and the upper projection 72a. In the present embodiment, among the substrates of the laminated substrates 79, the second damper frame 72, which is the second substrate, has the projection disposed on the outermost side of the common channel substrate 35 in the direction Y.

The common channel substrate 35 has a first groove 35b at a position facing the lower projection 71a in the lamination direction, and has a second groove 35c at a position facing the upper projection 72a. The second groove 35c is deeper in the direction Z than the first groove 35b.

The lower projection 71a and the upper projection 72a are portions in which the shape thereof is distorted by cutting in the manufacturing process, and correspond to the projection 23a (i.e., the distorted portion), for example, illustrated in FIG. 11 of the above-described embodiment. Accordingly, similarly to the above-described embodiment, the first groove 35b facing the lower projection 71a or the second groove 35c facing the upper projection 72a can enhance the bonding quality between the first damper frame 71 or the second damper frame 72 and the common channel substrate 35. For example, as illustrated in FIG. 25, even when the tip of the lower projection 71a is bent (curved), this bent portion can be housed in the first groove 35b to prevent the bent portion of the lower projection 71a and the flat face of the common channel substrate 35 from interfering with each other and deteriorating the bonding quality therebetween.

An adhesive 90 is applied between the common channel substrate 35 and the first damper frame 71 to bond the common channel substrate 35 and the first damper frame 71. At this time, as illustrated in FIG. 22, the adhesive 90 is also applied between the lower projection 71a and the first groove 35b, and the adhesive 90 contacts at least the bottom face of the lower projection 71a. The bottom face of the lower projection 71a is a lower face in FIG. 22, which faces the common channel substrate 35.

A procedure for bonding the common channel substrate 35, the first damper frame 71, and the second damper frame 72 will be described below. This procedure is a part of the method for manufacturing the liquid discharge head.

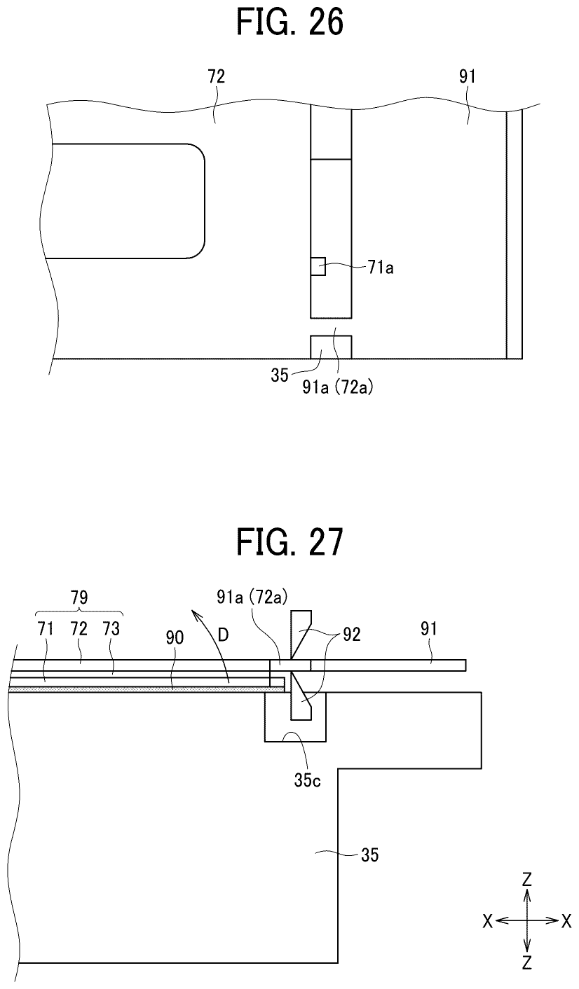

In a first bonding step, the first damper frame 71 connected to the gripping portion, the damper 73, and the second damper frame 72 connected to the gripping portion are bonded to each other by an adhesive. In a first cutting step, the connectors (i.e., the projections after the cutting step) connecting the gripping portions and these substrates are cut except for the connector disposed on the outermost side in the direction Y, and the gripping portions are cut off from the damper frame. As illustrated in FIG. 26, the connector disposed on the outermost side in the direction Y is a second connector 91a (the upper projection 72a after the cutting step) of the second damper frame 72, and the connector corresponding to the lower projection 71a is cut off in the first cutting step. When the gripping portions are connected to both sides of the damper frame in the direction X, the outermost connector refers to the connector (projection) disposed on the outermost side in the direction Y on each side.

By cutting off the connectors other than the outermost connector (i.e., the second connector 91a in FIG. 26) in the first cut step, only the second damper frame 72 is connected to a gripping portion 91 via the second connector 91a.

In a second bonding step, the adhesive 90 is applied to the common channel substrate 35, and the laminated substrates 79 are bonded to the common channel substrate 35. At this time, the bonding operation between the laminated substrates 79 and the common channel substrate 35 is performed while the laminated substrates 79 are held by gripping the gripping portion 91 connected to the second damper frame 72. In the second bonding step, the adhesive 90 is also applied between the projection and the groove including the lower projection 71a (first projection) and the first groove 35b. In a second cutting step, as illustrated in FIG. 27, the gripping portion 91 is cut off at the portion corresponding to the upper projection 72a by a cutter 92, and the gripping portion 91, which is the unnecessary portion, is separated from the second damper frame 72. By the above steps, the bonding operation between the common channel substrate 35 and the laminated substrates 79 is completed.

In the second cutting step, when the portion of the upper projection 72a is cut by the cutter 92, force in the direction D indicated by arrow D in FIG. 27 to peel off the first damper frame 71 from the common channel substrate 35 is applied to the first damper frame 71. Accordingly, if the bonding force between the laminated substrates 79 and the common channel substrate 35 is small, the first damper frame 71 may be separated from the common channel substrate 35.

In the present embodiment, as described above, the adhesive is applied between the lower projection 71a and the first groove 35b, and the adhesive contacts at least the bottom face of the lower projection 71a. By so doing, the bonding strength between the first damper frame 71 and the common channel substrate 35 can be enhanced. As a result, the first damper frame 71 can be prevented from peeling off from the common channel substrate 35 when the connector 91a (upper projection 72a) is cut. The adhesive applied between the lower projection 71a and the first groove 35b also contacts at least a part of the common channel substrate 35.

As illustrated in FIG. 24, a part of a bonded face 35e of the common channel substrate 35 bonded to the first damper frame 71 extends longer to the right in FIG. 24 than the first damper frame 71 (excluding the end face of the lower projection 71a). In other words, a portion 35e1 in a range E in FIG. 24 projects from the first damper frame 71. The portion 35e1 faces the upper projection 72a in the lamination direction. With such a configuration, the length from the upper projection 72a to the common channel substrate 35 in the lamination direction can be reduced, and the adhesive 90 can be held between the portion 35e1 and the upper projection 72a to reliably bond the portion 35e1 and the upper projection 72a. The upper projection 72a projects to the right in FIG. 24.

In the present embodiment, as in the above-described embodiment of the nozzle cover side illustrated in FIG. 13, an outer peripheral portion 35B of the common channel substrate 35 is disposed outside the projections which are the distorted portions. Such a configuration can prevent the foreign substances from contacting the end face of the projection, and can prevent the laminated substrates 79 having the projections from peeling off from the common channel substrate 35.

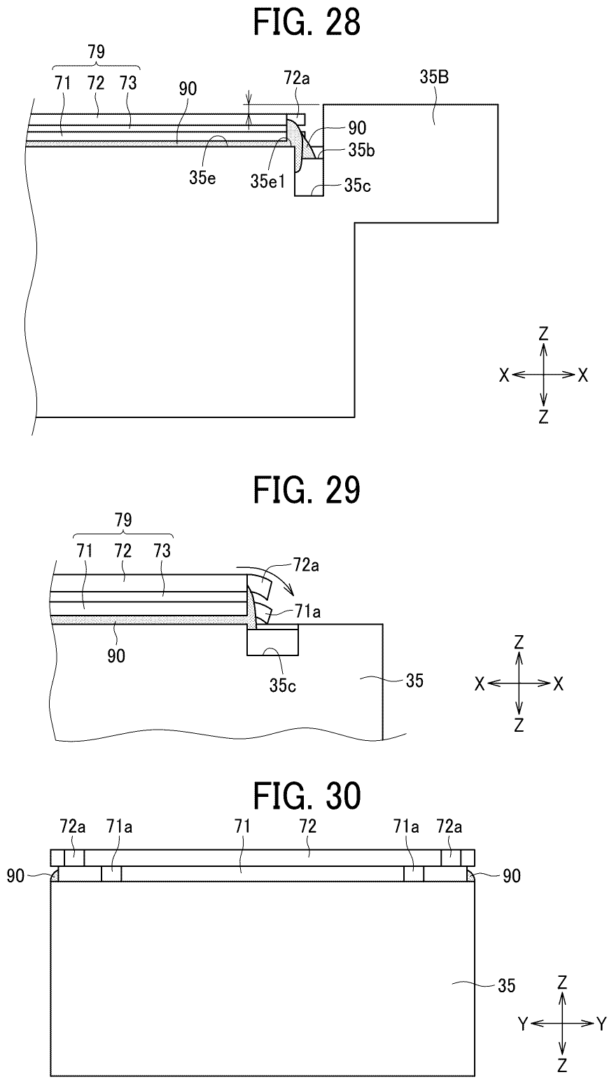

As illustrated in FIG. 28, the height of the outer peripheral portion 35B of the common channel substrate 35 in the lamination direction is higher than the laminated substrates 79. Such a configuration can prevent the load due to contact with another component from being applied to the upper projection 72a.

As illustrated in FIG. 22, the adhesive 90 for bonding the bottom face of the lower projection 71a and the first groove 35b may contact the side faces (faces on both sides in the direction Y) of the lower projection 71a or an end face 71b of the first damper frame 71. By either or both of these configurations, the adhesive area between the common channel substrate 35 and the first damper frame 71 can be increased to enhance the bonding strength. Accordingly, the first damper frame 71 and the second damper frame 72 can be prevented from peeling off from the common channel substrate 35. The end face 71b is a face on which the lower projection 71a of the first damper frame 71 is formed, i.e., a face to which the root of the lower projection 71a is connected.

In the present embodiment, the adhesive 90 is also applied between the upper projection 72a of the second damper frame 72 and the second groove 35c, and the adhesive 90 contacts at least the bottom face of the upper projection 72a. Such a configuration can enhance the bonding strength between the second damper frame 72 and the common channel substrate 35 and can prevent the first damper frame 71 or the second damper frame 72 from peeling off from the common channel substrate 35. The adhesive 90 applied between the upper projection 72a and the second groove 35c may contact the side face of the upper projection 72a or the end face 72b (face on which the upper projection 72a is formed) of the second damper frame 72. By either or both of these configurations, the adhesive area between the common channel substrate 35 and the second damper frame 72 can be increased to enhance the bonding strength. Accordingly, the first damper frame 71 and the second damper frame 72 can be further prevented from peeling off from the common channel substrate 35.

As illustrated in FIGS. 22 and 23, the second damper frame 72 has multiple through holes 72c, and the first damper frame 71 has multiple through holes 71c. The through hole 71c and the through hole 72c are formed between the lower projection 71a and the common channel 70 of the common channel substrate 35 in the direction X. These through holes 71c and 72c have a substantially circular cross section. The through hole 71c and the through hole 72c communicate with each other, but an embodiment of the present disclosure is not necessarily limited thereto. When the laminated substrates 79 includes three or more substrates, the through holes are preferably formed in all of the substrates.

The through holes 71c and the through holes 72c can reduce the strength of the first damper frame 71 and the second damper frame 72, which are laminated, in the portion of the through holes.

Accordingly, even when the first damper frame 71 peels off from the common channel substrate 35 in the second cutting step illustrated in FIG. 27, the peeling range can be limited to the portion having a low strength where the through holes 71c or the through holes 72c are disposed. Accordingly, the first damper frame 71 can be prevented from peeling off from the portion of the common channel substrate 35 where the common channel 70 is disposed. Thus, ink can be prevented from leaking from the common channel 70. The positions of the through holes 71c and the positions of the through holes 72c may be different from each other.

As illustrated in FIG. 29, the lower projection 71a or the upper projection 72a to which the adhesive 90 is applied is preferably curved toward the common channel substrate 35. Such a configuration can increase the adhesive area of the projection to which the adhesive 90 is applied to enhance the bonding strength to the common channel substrate 35.

As illustrated in FIG. 30, the width of the first damper frame 71 in the direction Y is preferably smaller than that of the common channel substrate 35. Such a configuration can prevent the adhesive 90 applied between the common channel substrate 35 and the first damper frame 71 from leaking to the outer peripheral face of the common channel substrate 35. Since the outer peripheral face of the common channel substrate 35 is used for positioning with respect to other components, preferably, the adhesive 90 does not leak to the outer peripheral face of the common channel substrate 35.

When the adhesive applied between the groove of the common channel substrate 35 and the projection contacts only the lower projection or only some of the projections including the lower projection among the multiple projections, preferably, the projection the adhesive contacts is not the projection disposed on the outermost side. For example, in the present embodiment, when the adhesive contacts only one of the projections, as illustrated in FIG. 22, the adhesive applied between the first groove 35b and the lower projection 71a preferably contacts the lower projection 71a and does not contact the upper projection 72a disposed on the outermost side of the common channel substrate 35 in the direction Y As described above, in order to hold each damper frame in the second bonding step, the gripping portion is connected to at least one of the substrates. In this case, the cutting operation in the second cutting step is facilitated by the outermost projection remaining as the connector connecting the substrate and the gripping portion. In other words, by bonding the inner projection to the common channel substrate 35 with the adhesive, the bonding strength between the first damper frame 71 and the common channel substrate 35 can be enhanced without reducing the workability in the second cutting step. The term “outermost side of the common channel substrate 35 in the direction Y” refers to the outer side in the direction from a center position toward each of the outer side faces of the common channel substrate 35 when the center position of the common channel substrate 35 in the direction Y is defined as the inner side.

As illustrated in FIG. 22, the second groove 35c facing the outermost upper projection 72a is preferably deeper than the other grooves (e.g., the first groove 35b in the present embodiment). Such a configuration facilitates the insertion of the cutter 92 in the second cutting step to enhance the workability.

The second groove 35c facing the outermost upper projection 72a preferably extends to the outer side face of the common channel substrate 35 in the direction Y Such a configuration facilitates the insertion of the cutter 92 in the second cutting step to enhance the workability.

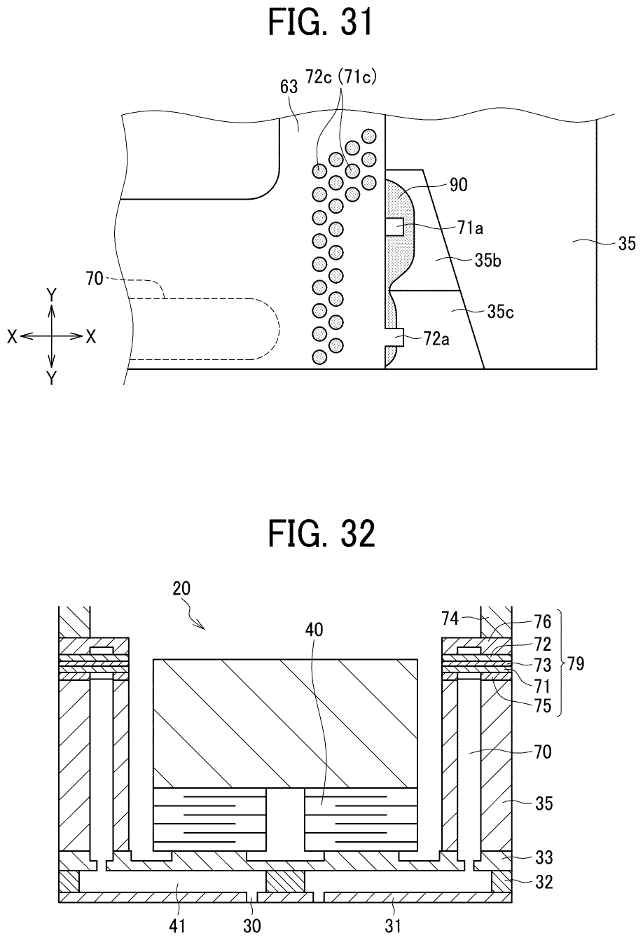

As illustrated in FIG. 31, the widths of the first groove 35b and the second groove 35c in the direction X can be increased toward the outer side face of the common channel substrate 35 in the direction Y Such a configuration facilitates the insertion of the cutter 92 into the first groove 35b or the second groove 35c to enhance the workability of the cutting by the cutter 92. Either the width of the first groove 35b or the width of the second groove 35c may be increased toward the outer side face. The shape of the groove is not limited to the tapered shape as illustrated in FIG. 31, and the width of the groove may be increased toward the outer side face in a stepwise manner.

The outermost projection among the projections of the substrates in the laminated substrates is preferably the thinnest projection. Such a configuration can reduce the stress generated by cutting in the second cutting step, and thus the peeling of the first damper frame 71 from the common channel substrate 35 can be prevented.

In the above description, the substrates having the projections (connectors) constructing the laminated substrates are two substrates of the first damper frame 71 and the second damper frame 72. However, an embodiment of the present disclosure is not limited thereto.

For example, the laminated substrates 79 of the liquid discharge head 20 illustrated in FIG. 32 includes a first damper manifold 75 as the first substrate and a second damper manifold 76 in addition to the first damper frame 71 as the first substrate, the second damper frame 72 as the second substrate, and the damper 73. The first damper manifold 75, the first damper frame 71, the damper 73, the second damper frame 72, and the second damper manifold 76 are laminated and bonded in this order onto the common channel substrate 35. In the present embodiment, the first damper manifold 75 is the first substrate bonded to the common channel substrate 35. The common channel substrate 35 is referred to as the first bonding component or the second component.

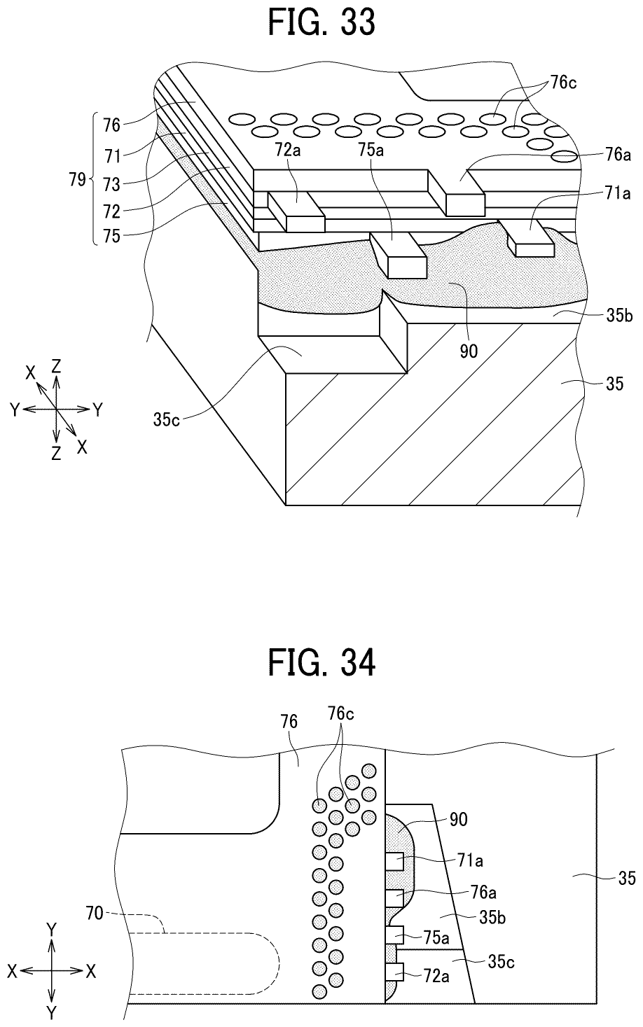

As illustrated in FIG. 33, the projections in the laminated substrates 79 includes a lowermost projection 75a of the first damper manifold 75 as the first projection and an uppermost projection 76a of the second damper manifold 76 in addition to the lower projection 71a of the first damper frame 71 as the first projection and the upper projection 72a of the second damper frame 72 as the second projection. The upper projection 72a, the lowermost projection 75a, the uppermost projection 76a, and the lower projection 71a are arranged in this order from the outer side face toward the center position of the common channel substrate 35. In the present embodiment, the second substrate having the upper projection 72a which is the projection arranged on the outermost side in the direction Y is the second damper frame 72. The projections other than the upper projections 72a are cut in the first cutting step, and the upper projection 72a is cut in the second cutting step.

The lowermost projection 75a, the uppermost projection 76a, and the lower projection 71a face the first groove 35b. The upper projection 72a faces the second groove 35c. The respective projections do not overlap each other. In the following description, the configuration of the liquid discharge head of FIG. 33 is referred to as Example A.

In the present embodiment, the adhesive 90 applied between the lowermost projection 75a and the first groove 35b contacts the bottom face of the lowermost projection 75a, and the adhesive 90 applied between the lower projection 71a and the first groove 35b contacts the bottom face of the lower projection 71a. The adhesive 90 may contact only one of the lowermost projection 75a and the lower projection 71a. At least one of these configurations enhances the bonding strength between the laminated substrates 79 and the common channel substrate 35, and prevents the laminated substrates 79, in particular, the first damper manifold 75, from peeling off from the common channel substrate 35. However, the adhesive 90 applied between the other projections and the groove may contact at least the bottom face of the other projections, or the adhesive 90 may contact the side face of the other projections or the end face of the substrate having the projection. Such configurations enhance the bonding strength between the laminated substrates 79 and the common channel substrate 35, and prevents the laminated substrates 79 from peeling off from the common channel substrate 35.

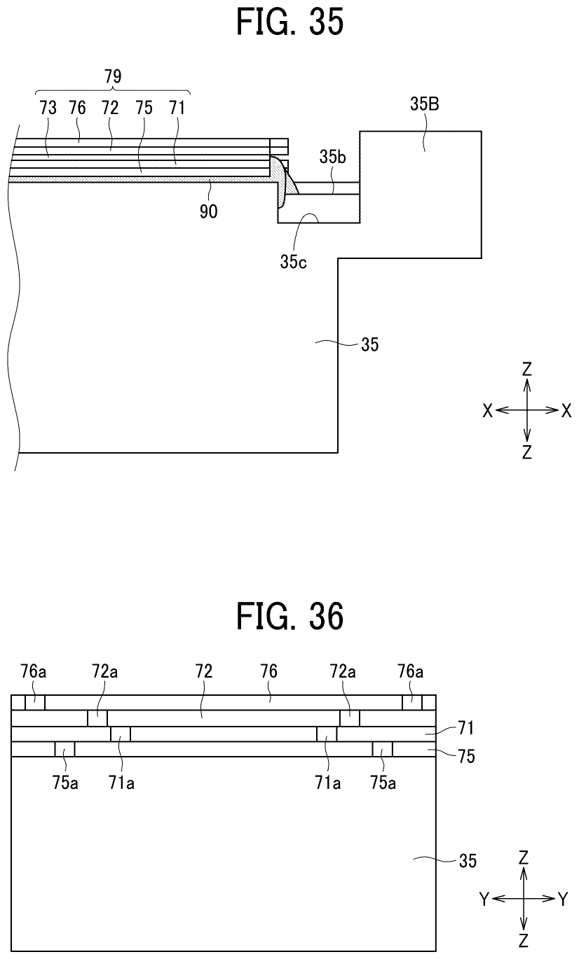

In the present embodiment, the configurations of the above-described embodiments can be adopted. For example, the second groove 35c is deeper than the first groove 35b. Through holes are formed between the projection and the common channel 70 in each damper frame and each damper manifold. Although through holes 76c of the second damper manifold 76 are illustrated in FIG. 33, through holes are formed in other substrates in the similar manner. The second groove 35c extends to the outer side face of the common channel substrate 35 in the left-right direction in FIG. 33 (i.e., the direction Y). The outermost upper projection 72a is the thinnest of the projections. As illustrated in FIG. 34, the widths of the first groove 35b and the second groove 35c in the direction X are increased toward the outer side face of the common channel substrate 35. As illustrated in FIG. 35, a part of a bonded face of the common channel substrate 35 bonded to the first damper manifold 75 extends longer to the right in FIG. 35 than the first damper manifold 75 (excluding the end face of the lowermost projection 75a). The height of the outer peripheral portion 35B of the common channel substrate 35 is higher than the second damper manifold 76. Similarly to the first damper frame 71 illustrated in FIG. 30, the end face of the first damper manifold 75 in the left-right direction of FIG. 30 is disposed inside the end face of the common channel substrate 35.

The order of the arrangement of the projections in the direction Y is not limited to the above example. For example, in FIG. 36, the uppermost projection 76a, the lowermost projection 75a, the upper projection 72a, and the lower projection 71a are arranged in this order from the outer side face toward the center position of the common channel substrate 35 in the direction Y In this case, the lowermost projection 75a which is the second from the outer side face preferably contacts the adhesive between the projections and the groove of the common channel substrate 35. Such a configuration can increase the strength of the portion closest to the uppermost projection 76a when the outermost uppermost projection 76a is cut in the second cutting step. Such a configuration can prevent the peeling of the first damper manifold 75 in the second cutting step. A projection other than the lowermost projection 75a may contact the adhesive between the projection and the groove of the common channel substrate 35.

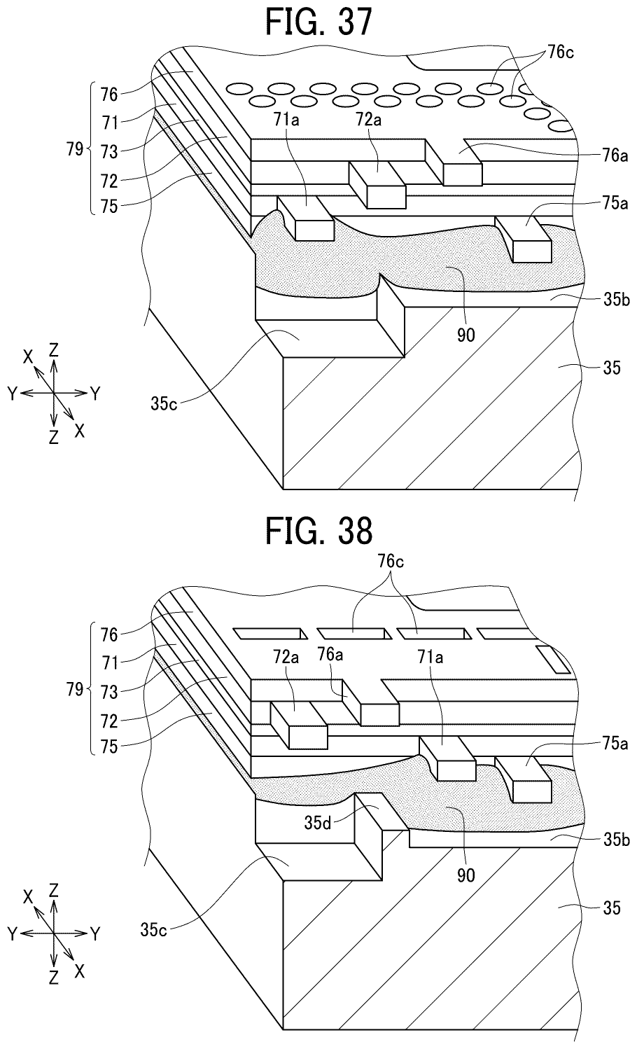

FIG. 37 illustrates a liquid discharge head of Example B as another example. As illustrated in FIG. 37, the present embodiment is different from the embodiment of FIG. 33 in that the lower projection 71a, the upper projection 72a, the uppermost projection 76a, and the lowermost projection 75a are arranged in this order from the outer side face toward the center position of the common channel substrate 35. The lower projection 71a and the upper projection 72a face the second groove 35c. The uppermost projection 76a and the lowermost projection 75a face the first groove 35b.

The adhesive 90 applied between the lowermost projection 75a and the first groove 35b contacts at least the bottom face of the lowermost projection 75a. The adhesive 90 applied between the lower projection 71a and the second groove 35c contacts at least the bottom face of the lower projection 71a. The first damper manifold 75 having the lowermost projection 75a as the first projection is the first substrate of the present embodiment. For example, the first damper frame 71 having the lower projection 71a which is the outermost projection can be used as the second substrate.

Unlike the above-described embodiment, the outermost lower projection 71a is not thinner than the other projections. As in the above-described embodiment, the lowermost projection 75a contact the adhesive 90 applied between the lowermost projection 75a and the first groove 35b.

FIG. 38 illustrates a liquid discharge head of Example C as still another example. As illustrated in FIG. 38, the present embodiment is different from the embodiments of FIGS. 33 and 35 in that the upper projection 72a, the uppermost projection 76a, the lower projection 71a, and the lowermost projection 75a are arranged in this order from the outer side face toward the center position of the common channel substrate 35. The upper projection 72a faces the second groove 35c. The lower projection 71a and the lowermost projection 75a face the first groove 35b. A protrusion 35d protruding from the first groove 35b and the second groove 35c is disposed between the first groove 35b and the second groove 35c. The height of the protrusion 35d is the same as that of the peripheral portion of the common channel substrate 35 other than the groove. The uppermost projection 76a faces the protrusion 35d.

The adhesive 90 applied between the lowermost projection 75a and the first groove 35b contacts at least the bottom face of the lowermost projection 75a. The adhesive 90 applied between the lower projection 71a and the first groove 35b contacts at least the bottom face of the lower projection 71a. The lowermost projection 75a or the lower projection 71a can serve as the first projection, and the first damper manifold 75 or the first damper frame 71 can serve as the first substrate having the first projection. For example, the second damper frame 72 having the upper projection 72a which is the outermost projection can serve as the second substrate.

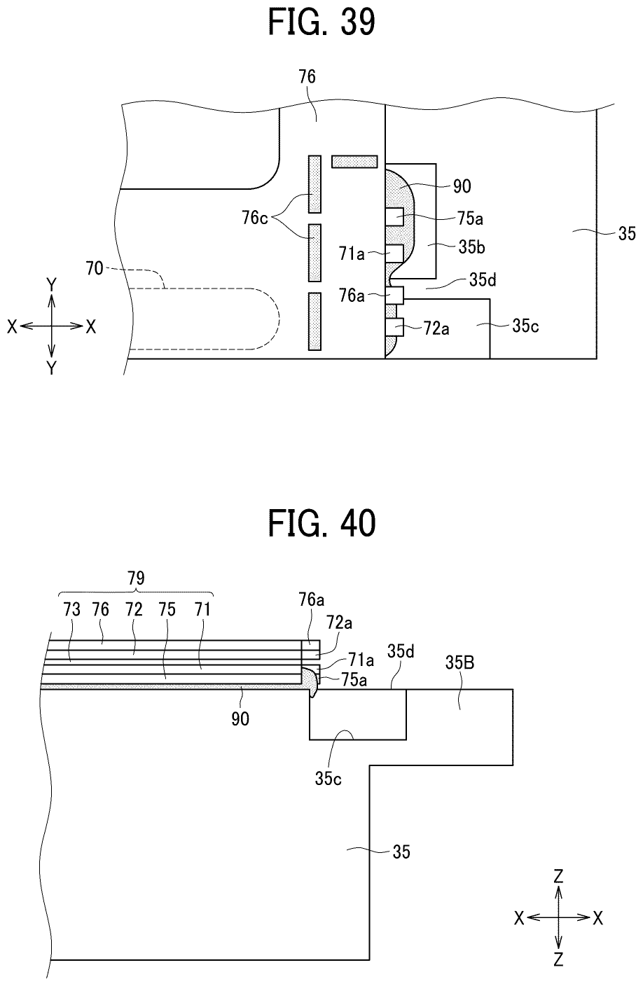

Unlike the above-described embodiment, the outermost upper projection 72a is not thinner than the other projections. In the present embodiment, as illustrated in FIGS. 38 and 39, the through holes such as the through holes 76c formed in the second damper manifold 76 has a rectangular cross section. The through holes 76c are uniformly arranged. As illustrated in FIG. 40, the outer peripheral portion 35B is disposed at the same height as the bonded portion of the common channel substrate 35 with the first damper manifold 75 and lower than the laminated substrates 79.

In the above Examples A to C, the bonding strength between the laminated substrates 79 and the common channel substrate 35 can be increased by the contact of the first projection with the adhesive applied between the first projection and the first groove. Accordingly, the peeling of the laminated substrates 79, in particular, the first damper manifold 75, from the common channel substrate 35 can be prevented.

Test conditions for testing the peel strength and other properties, and the results thereof for the above Examples A to C and Comparative Example will be described below.

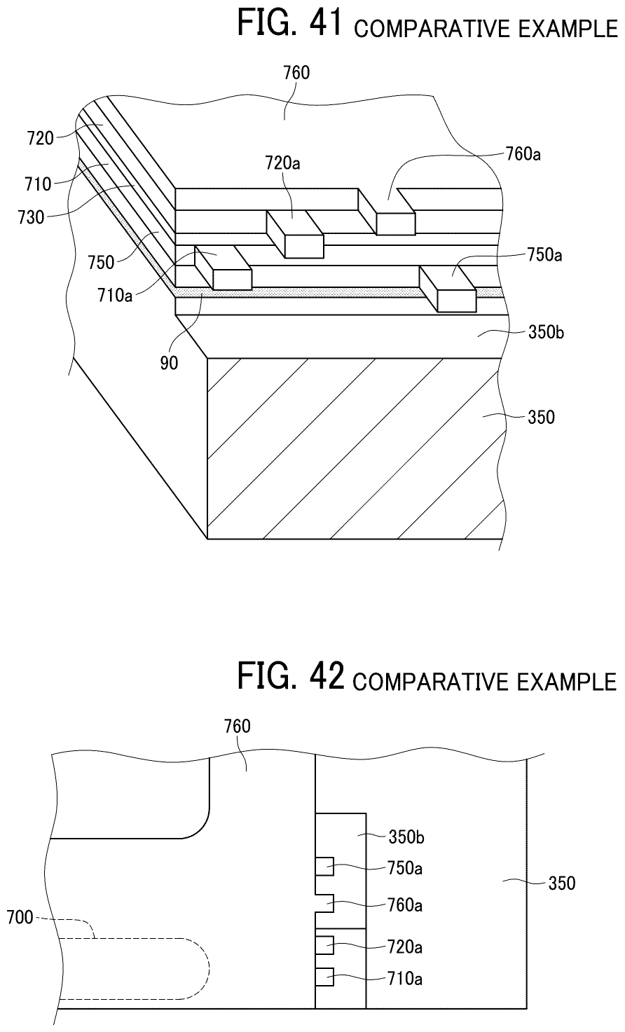

A liquid discharge head according to a comparative example different from the embodiments of the present disclosure will be described below with reference to FIGS. 41 to 43.

As illustrated in FIG. 41, a first damper manifold 750 having a lowermost projection 750a, a first damper frame 710 having a lower projection 710a, a damper 730, a second damper frame 720 having an upper projection 720a, and a second damper manifold 760 having an uppermost projection 760a are laminated on a common channel substrate 350.

The lower projection 710a, the upper projection 720a, the uppermost projection 760a, and the lowermost projection 750a are arranged in this order from the outer side face toward the center position of the common channel substrate 350. A groove 350b is formed in the common channel substrate 350 so as to face these projections. In other words, in the comparative example, the depth of the groove 350b facing the projections is uniform. The adhesive 90 does not protrude toward the projections, and the adhesive 90 is not applied between the projections and the groove 350b.

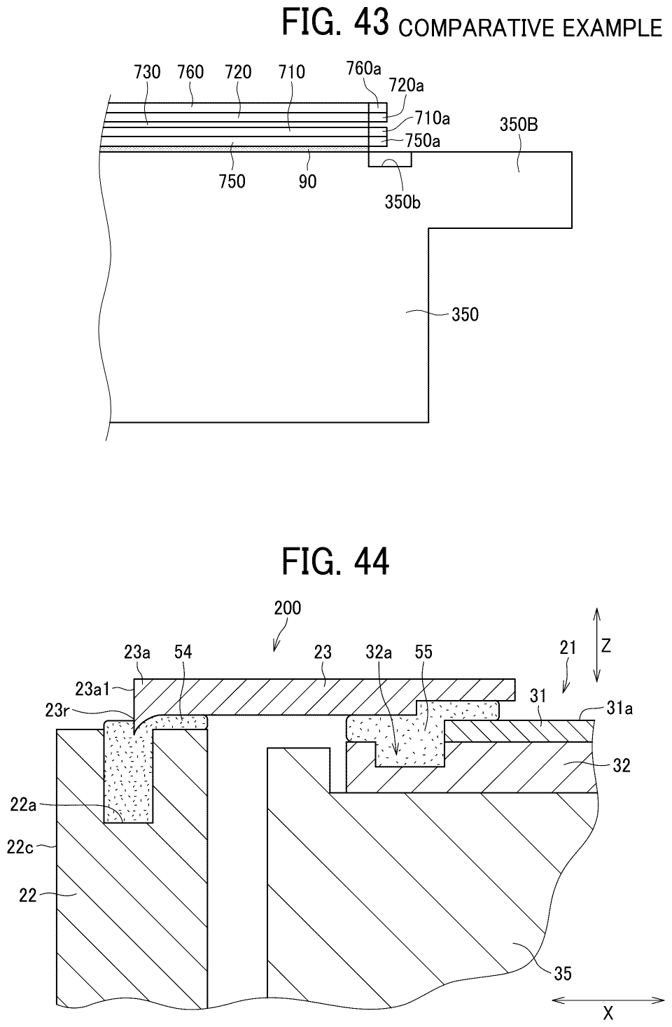

No through hole is formed in the second damper manifold 760 and other substrates. As illustrated in FIG. 42, the width of the groove 350b in the left-right direction in FIG. 42 is uniform in the vertical direction in FIG. 42. As illustrated in FIG. 43, the height of an outer peripheral portion 350B of the common channel substrate 350 is the same as the height of the portion of the common channel substrate 350 bonded to the first damper manifold 750 and lower than the laminated substrates such as the second damper manifold 760.

The evaluation items by the test are the following three items.
Evaluation 1: Peel strength and peeling range (extension) when load is applied to the projection
Evaluation 2: Occurrence rate of channel leak in second cutting step
Evaluation 3: Applicability of cutter

In Evaluation 1, a peeling test is performed. In the peeling test, a load is applied to the outermost projection in a direction to peel off the first damper manifold from the common channel substrate, and the load when the first damper manifold peels off and the range (extension) of the peeling are evaluated. In Evaluation 2, after the first bonding step, the first cutting step, the second bonding step, and the second cutting step are performed, the sealing properties of the channel formed in the liquid discharge head are evaluated by a leak test. In Evaluation 3, a commercially available cutter such as a nipper is used to determine whether the second cutting step can be performed. The determination of whether the second cutting step can be performed is based on three criteria: a first criterion is whether the blade of the cutter reaches the projection; a second criterion is whether the projection can be cut, and a third criterion is whether the first damper manifold peels off by cutting. For each of Examples A to C and Comparative Example, the test was performed using 30 liquid discharge heads in Evaluation 1 and Evaluation 2, and 15 types of cutters were used in Evaluation 3.

The results of the above evaluation tests are illustrated in Table 1.

TABLE 1

| | | | | | COMPAR- | THE |
|---|---|---|---|---|---|---|
| EVALUA- | | | | | ATIVE | NUMBER OF |
| TION | ITEM | EXAMPLE A | EXAMPLE B | EXAMPLE C | EXAMPLE | HEADS (N) |
| 1 | PEEL | 2.6 | 2.2 | 2.3 | 1.1 | 30 HEADS |
| | STRENGTH | | | | | |
| | (N | | | | | |
| | PEELING | to | to | to | reach | 30 HEADS |
| | RANGE | THROUGH | THROUGH | THROUGH | COMMON | |
| | | HOLES | HOLES | HOLES | CHANNEL | |
| 2 | LEAK | 0.0% | 0.0% | 0.0% | 36.7% | 30 HEADS |
| | OCCURRENCE | | | | | |
| | RATE | | | | | |
| 3 | APPLICABILITY | 86.7% | 86.7% | 80.0% | 6.7% | 15 (THE |
| | | | | | | NUMBER OF |
| | | | | | | TYPES OF |
| | | | | | | CUTTERS) |

In Evaluation 1, the peel strength of Comparative Example was 1.1 N. The peel strengths of Examples A to C were 2.6, 2.2, and 2.3 N, which were all twice or more the peel strength of Comparative Example. This is because the adhesive was squeezed out toward the groove in each of Examples A to C. Accordingly, the adhesive was applied between the projection and the groove (in particular, between the first projection and the first groove), and the adhesive contacts the projection to increase the bonding strength. In particular, Example A in which various measures were prepared was most excellent in peel strength.

Regarding the peeling range, the peeling reached the channel (e.g., a common channel 700) in Comparative Example. On the other hands, the peeling extended to the through holes but did not reach the channel in all of Examples A to C. Thus, the through holes between the projection and the channel can block the extension of the peeling. In Evaluation 2, the leak of ink occurred at 36.7% in Comparative Example, but the leak of ink did not occur (i.e., leak occurrence rate was 0%) in Examples A to C.

In Evaluation 3, the applicability is 6.7% in Comparative Example, and the applicability are 86.7%, 86.7%, and 80.0% in Examples A to C, respectively. The reason why Examples A to C are superior to Comparative Example is that the depth of the outer second groove 35c is deeper than the first groove 35b. For this reason, the cutter can be easily inserted. In addition, the reason why Examples A and B are superior to Example C is that the width of the groove is increased toward the outer side face.

As described above, Examples A to C are superior to Comparative Examples in the bonding strength with the common channel substrate and the workability in the second cutting step.

The above-described embodiments are illustrative and do not limit the present disclosure. Numerous additional modifications and variations are possible in light of the above teachings. It is therefore to be understood that within the scope of the appended claims.

The foreign substance that collides with the liquid discharge head may be a sheet onto which the liquid discharge head discharges liquid, or foreign matter on the sheet, but an embodiment of the present disclosure is not limited thereto. The embodiments of the present disclosure are also applicable to a liquid discharge head of a liquid discharge apparatus that does not convey a sheet.

As a liquid discharge apparatus including the liquid discharge head, an electrode manufacturing apparatus that manufactures an electrode and an electrochemical element will be described below with reference to FIG. 17. FIG. 17 is a schematic view of an electrode manufacturing apparatus. The electrode manufacturing apparatus is an apparatus for manufacturing an electrode including a layer containing an electrode material by discharging a liquid composition using a liquid discharge head.

A discharge device in the electrode manufacturing apparatus illustrated in FIG. 17 is the liquid discharge head according to the above-described embodiments of the present disclosure. The liquid discharge head discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

As an example of the electrode manufacturing apparatus, an electrode manufacturing apparatus that forms an electrode composite layer containing an active material on an electrode substrate, i.e., a current collector, is described below. As illustrated in FIG. 17, the electrode manufacturing apparatus includes a discharge process device 610 and a heating process device 620. The discharge process device 610 performs a discharge process of applying a liquid composition onto a print base material 604 having a discharge target to form a liquid composition layer. The heating process device 320 performs a heating process of heating the liquid composition layer to obtain an electrode composite layer.

The electrode manufacturing apparatus includes a conveyor 605 that conveys the print base material 604. The conveyor 605 conveys the print base material 604 to the discharge process device 610 and the heating process device 620 in this order at a preset speed. A method of producing the print base material 604 having the discharge target such as an active material layer is not limited to any particular method, and a known method can be appropriately selected. The discharge process device 610 includes the liquid discharge head 20 that performs an application process of applying a liquid composition 607 onto the print base material 604, a storage container 601 that stores the liquid composition 607, and a supply tube 602 that supplies the liquid composition 607 stored in the storage container 601 to the liquid discharge head 20.

The discharge process device 610 discharges the liquid composition 607 from the liquid discharge head 20 so that the liquid composition 607 is applied onto the print base material 604 to form a liquid composition layer in a thin film shape. The storage container 601 may be integrated with the electrode manufacturing apparatus that forms the electrode composite layer or may be detachable from the electrode manufacturing apparatus. The storage container 601 may be a container additionally attachable to a container integrated with the electrode manufacturing apparatus for manufacturing the electrode composite layer or to a container detachable from the electrode manufacturing apparatus for manufacturing the electrode composite layer. The storage container 601 that stably stores the liquid composition 607 and the supply tube 602 that stably supplies the liquid composition 607 can be used.

The heating process device 620 performs a solvent removal process of heating and removing the solvent remaining in the liquid composition layer. Specifically, the solvent that remains in the liquid composition layer is heated and dried by a heater 603 of the heating process device 620. Accordingly, the solvent is removed from the liquid composition layer. Thus, the electrode composite layer is formed. The heating process device 620 may perform the solvent removing process under reduced pressure.

The heater 603 is not limited to any particular heater and may be appropriately selected depending on the intended purpose. For example, the heater 603 may be a substrate heater, an infrared (IR) heater, or a hot air heater. The heater 603 may be a combination of at least two of the substrate heater, the IR heater, and the hot air heater. A heating temperature and heating time can be appropriately selected according to the boiling point of the solvent contained in the liquid composition 607 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

In the present disclosure, the term “liquid discharge head (head)” used herein is a functional component to discharge liquid through the nozzles. Liquid to be discharged through the nozzles of the liquid discharge head is not limited to a particular liquid as long as the liquid has a viscosity or surface tension to be discharged from the liquid discharge head. However, preferably, the viscosity of the liquid is not greater than 30 millipascal-second (mPa·s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The liquid discharge head may include multiple head bodies as in the above-described embodiment or may include one head body.

Examples of an energy source for generating energy to discharge liquid include a piezoelectric actuator (a laminated piezoelectric element or a thin-film piezoelectric element), a thermal actuator that employs a thermoelectric transducer element, such as a thermal resistor, and an electrostatic actuator including a diaphragm and opposed electrodes.

In the present disclosure, the “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. The liquid discharge unit may include the liquid discharge head, the carriage, and the main-scanning moving mechanism that are integrated as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge device includes a tube connected to the liquid discharge head mounting the head tank or the channel component so that the liquid discharge head and the supply mechanism are integrated as a single unit. Through the tube, the liquid in a liquid storage source is supplied to the liquid discharge head.

The main-scanning moving mechanism may be a guide only. The supply mechanism may be a tube(s) only or a loading device only.

The term “liquid discharge apparatus” used herein also represents an apparatus including the liquid discharge head or the liquid discharge unit to drive the liquid discharge head to discharge liquid. The term “liquid discharge apparatus” used here includes, in addition to apparatuses to discharge liquid to a medium onto which liquid can adhere, apparatuses to discharge the liquid into gas (air) or liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a sheet such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

Further, the sheet may be continuous sheet (e.g., rolled paper) formed in an elongated shape or cut paper cut in advance into a predetermined size. The present disclosure is also applicable to an apparatus that conveys an object other than the sheet.

The term “liquid discharge apparatus” may be an apparatus in which the liquid discharge head and the medium onto which liquid can adhere move relative to each other. However, the liquid discharge apparatus is not limited to such an apparatus. For example, the liquid discharge apparatus may be a serial head apparatus (see FIG. 6) that moves the liquid discharge head or a line head apparatus (see FIG. 5) that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

Aspects of the present disclosure are, for example, as follows.

### Aspect 0

A liquid discharge head includes a first component and a second component. The first component has a projection projecting in a first direction. The second component is bonded to the first component in a second direction orthogonal to the first direction. The second component has a front peripheral face facing the first component and a side peripheral face intersecting the front peripheral face. The front peripheral face has a groove disposed at a position facing the projection and recessed in a third direction opposite to the second direction. The groove is inside the side peripheral face in a fourth direction opposite to the first direction.

### Aspect 1

A liquid discharge head includes a nozzle component having a nozzle, a nozzle cover covering the nozzle component, and a nozzle-side bonded component bonded to the nozzle cover. The nozzle cover has a distorted portion which is a portion including an outer peripheral face of the nozzle cover and is partially distorted in shape from a peripheral portion. The nozzle-side bonded component has a through hole or a recess at a position facing the distorted portion. The through hole or the recess is disposed inside the nozzle-side bonded component and does not face the outside of the nozzle-side bonded component when viewed in a direction in which the nozzle cover and the nozzle-side bonded component are overlapped.

In other words, the liquid discharge head according to Aspect 0, further includes a nozzle plate having a nozzle. The first component includes a nozzle cover covering the nozzle plate. The second component includes a base bonded to the nozzle cover. The projection includes a portion of an outer edge of the nozzle cover which projects from a surrounding outer edge in the first direction. The groove includes a recess or a through hole facing the portion of the outer edge of the nozzle cover.

### Aspect 2

A liquid discharge head includes a nozzle component having a nozzle, a nozzle cover covering the nozzle component, and a nozzle-side bonded component bonded to the nozzle cover. The nozzle cover has a projection projecting toward outer peripheral side than the other portions. The nozzle-side bonded component has a through hole or a recess at a position facing the projection. The through hole or the recess is disposed inside the nozzle-side bonded component and does not face the outside of the nozzle-side bonded component when viewed in a direction in which the nozzle cover and the nozzle-side bonded component are overlapped.

In other words, the liquid discharge head according to Aspect 0, further includes a nozzle plate having a nozzle. The first component includes laminated substrates including a plurality of substrates. The second component includes a common channel substrate bonded to the laminated substrates. The common channel substrate has a common channel communicating with the nozzle of the nozzle plate. The projection includes a portion of an outer edge of the laminated substrates which projects from a surrounding outer edge in the first direction. The groove includes a recess or a through hole facing the portion of the outer edge of the laminated substrates.

### Aspect 3

In the liquid discharge head according to Aspect 1 or 2, the nozzle-side bonded component has a through hole at a position facing the distorted portion or the projection, and the through hole is a screw hole.

In other words, in the liquid discharge head according to any one of Aspects 0 to 2, the groove has a through hole having a thread.

### Aspect 4

In the liquid discharge head according to any one of Aspects 1 to 3, the through hole or the recess is filled with an adhesive to be bonded to the distorted portion or the projection.

In other words, in the liquid discharge head according to any one of Aspects 0 or 3, the groove is filled with an adhesive to bond the projection of the first component to the second component.

### Aspect 5

In the liquid discharge head according to any one of Aspects 1 to 4, the outer peripheral face of the nozzle cover disposed in the distorted portion is a cut surface.

In other words, in the liquid discharge head according to any one of Aspects 0 to 4, the projection projects from an outer edge of the first component, and the projection has an end face in the first direction as a cut surface.

### Aspect 6

In the liquid discharge head according to Aspect 5, the recess or the through hole faces the cut surface.

In other words, in the liquid discharge head according to Aspect 5, the groove faces the cut surface of the projection.

### Aspect 7

A liquid discharge head includes a first bonding component and laminated substrates which include at least a first substrate and a second substrate laminated and are bonded to the first bonding component. The first substrate includes a first projection. The second substrate includes a second projection projecting in the same direction as the first projection. The first bonding component includes a first groove facing the first projection. An adhesive applied between the first projection and the first groove contacts a face of the first projection facing the first groove.

In other words, in the liquid discharge head according to any one of Aspects 0 to 6, the first component is laminated substrates including at least a first substrate and a second substrate laminated one on another. The laminated substrates are bonded to the second component. The first substrate has the projection. The second substrate has another projection projecting in the first direction. The groove faces the projection. An adhesive applied between the projection and the groove contacts a face of the projection facing the groove.

### Aspect 8

In the liquid discharge head according to Aspect 7, the second projection is disposed at a position not overlapping the first projection when viewed in a lamination direction of the first substrate and the second substrate.

In other words, in the liquid discharge head according to Aspect 7, said another projection is shifted from the projection in a fifth direction orthogonal to the first direction and the second direction.

### Aspect 9

In the liquid discharge head according to Aspect 8, the second projection is disposed outside the first projection in a direction perpendicular to the lamination direction of the first substrate and the second substrate and different from a projecting direction of the first projection, when a center side of the first bonding component is defined as inside and an end portion side is defined as outside.

In other words, in the liquid discharge head according to Aspect 8, said another projection is closer to an outer side face of the second component than the projection in the fifth direction. The outer side face intersects the front peripheral face and the side peripheral face.

### Aspect 10

In the liquid discharge head according to Aspect 9, the laminated substrates include multiple projections including the first projection and the second projection. The liquid discharge head according to claim 9,

In other words, in the liquid discharge head according to Aspect 9, the laminated substrates include multiple projections including the projection and said another projection. Said another projection is closest to the outer side face of the second component among the multiple projections. The second component further includes another groove facing said another projection. Said another groove is deeper than the groove in the third direction.

### Aspect 11

In the liquid discharge head according to Aspect 10, a face of the second projection on the second groove side and the second groove are bonded to each other with an adhesive.

In other words, in the liquid discharge head according to Aspect 10, a face of said another projection facing said another groove and the second component are bonded to each other with the adhesive.

### Aspect 12

In the liquid discharge head according to Aspect 11, the adhesive between the second projection and the second groove contacts a side surface of the second projection.

### Aspect 13

In the liquid discharge head according to Aspect 11 or 12, the adhesive between the second projection and the second groove contacts an end face of the second substrate on which the second projection is formed.

### Aspect 14

In the liquid discharge head according to any one of Aspects 10 to 13, the second groove extends to an end portion of the first bonding component in the direction perpendicular to the lamination direction of the first substrate and the second substrate and different from the projecting direction of the first projection.

In other words, in the liquid discharge head according to any one of Aspects 10 to 13, said another groove extends to the outer side face of the second component in the fifth direction.

### Aspect 15

In the liquid discharge head according to any one of Aspects 10 to 14, at least one of the first groove and the second groove has a width larger on the outside than on the inside.

In other words, in the liquid discharge head according to any one of Aspects 10 to 14,
a width of at least one of the groove or said another groove increase toward the outer side face of the second component in the fifth direction.

### Aspect 16

In the liquid discharge head according to any one of Aspects 8 to 15, the first bonding component has an outer peripheral portion which is located on an outer peripheral side of the first bonding component with respect to the first groove and which is higher than the laminated substrates.

In other words, in the liquid discharge head according to any one of Aspects 8 to 15, the second component has an outer peripheral portion disposed on an outer side of the groove, and the outer peripheral portion is higher than the laminated substrates.

### Aspect 17

In the liquid discharge head according to any one of Aspects 8 to 16, the laminated substrates include multiple projections including the first projection and the second projection. A thinnest projection among the multiple projections is disposed on the outermost side among the multiple projections, when a center side of the first bonding component is defined as inside and an end portion side is defined as outside in a direction perpendicular to the lamination direction of the first substrate and the second substrate and different from a projecting direction of the first projection.

In other words, in the liquid discharge head according to any one of Aspects 8 to 16, the laminated substrates include multiple projections including the projection and said another projection. A thinnest projection of the multiple projections having a thinnest thickness in the second direction is closest to an outer side face of the second component in the fifth direction among the multiple projections.

### Aspect 18

In the liquid discharge head according to any one of Aspects 8 to 17, the laminated substrates include multiple projections including the first projection and the second projection. The first projection is disposed on the second outermost side among the multiple projections.

In other words, in the liquid discharge head according to any one of Aspects 8 to 17, the laminated substrates include multiple projections including the projection and said another projection. The projection is second closest to an outer side face of the second component in the fifth direction among the multiple projections.

### Aspect 19

In the liquid discharge head according to any one of Aspects 8 to 18, the laminated substrates include multiple projections including the first projection and the second projection. At least one of the projections is curved toward the first bonding component.

In other words, in the liquid discharge head according to any one of Aspects 8 to 18, the laminated substrates include multiple projections including the projection and said another projection. At least one of the multiple projections is curved toward the second component.

### Aspect 20

In the liquid discharge head according to any one of Aspects 8 to 19, the first bonding component has a common channel which is a flow path of liquid therein. A through hole which penetrates the laminated substrates is provided. The through hole is disposed between the first projection and the common channel when viewed in the lamination direction of the first bonding component and the laminated substrates.

In other words, in the liquid discharge head according to any one of Aspects 8 to 19, the second component has a common channel through which a liquid flows inside the second component. The laminated substrates have through holes between the projection and the common channel in the first direction, and the through holes penetrate the laminated substrates.

### Aspect 21

In the liquid discharge head according to any one of Aspects 8 to 20, the first substrate is disposed closer to the first bonding component than the second substrate. The first bonding component has a bonded portion with the first substrate in a part thereof, and has a bonded face extending to a projecting side of the second projection than the first substrate. A portion of the bonded face projecting to the projecting side of the second projection than the first substrate faces the second projection when viewed in the lamination direction of the first bonding component and the laminated substrates.

### Aspect 22

In the liquid discharge head according to any one of Aspects 8 to 21, the adhesive between the first projection and the first groove contacts the side face of the first projection.

### Aspect 23

In the liquid discharge head according to any one of Aspects 8 to 22, the adhesive between the first projection and the first groove contacts an end face of a portion of the first substrate different from the first projection.

### Aspect 24

In the liquid discharge head according to any one of Aspects 8 to 23, the first substrate is disposed closer to the first bonding component than the second substrate. A width of the first substrate is smaller than a width of the first bonding component in a direction perpendicular to the lamination direction of the first bonding component and the laminated substrates and different from a projecting direction of the first projection.

### Aspect 25

A liquid discharge apparatus includes the liquid discharge head according to any one of Aspects 1 to 24.

In other words, a liquid discharge apparatus includes the liquid discharge head according to any one of Aspects 0 to 24, to discharge a liquid to a medium and a conveyor to convey the medium to the liquid discharge head.

### Aspect 26

In a method of manufacturing a liquid discharge head including a first bonding component and a laminated substrates which includes at least a first substrate and a second substrate laminated one on another and is bonded to the first bonding component, the first substrate is connected to a gripping portion via a first projection, and the second substrate is connected to a gripping portion via a second projection. The second projection is disposed at a position not overlapping the first projection when viewed in a lamination direction of the first substrate and the second substrate. The first bonding component has a first groove facing the first projection. The method includes: a first bonding step to bond the first substrate and the second substrate; a first cutting step to cut a portion of the first projection to separate the first substrate and the gripping portion; a second bonding step to hold the gripping portion, apply an adhesive between the first projection and the first bonding component including between the first projection and the first groove, and bond the first substrate and the first bonding component; and a second cutting step to cut a portion of the second projection to separate the laminated substrates and the gripping portion.

As described above, according to one aspect of the present disclosure, the components (substrates) bonded to one on another can be prevented from peeling off.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a first component having a projection projecting in a first direction; and
a second component bonded to the first component in a second direction orthogonal to the first direction,
the second component having a front peripheral face facing the first component and a side peripheral face intersecting the front peripheral face,
wherein the front peripheral face has a groove disposed at a position facing the projection and recessed in a third direction opposite to the second direction, and
the groove is inside the side peripheral face in a fourth direction opposite to the first direction.

2. The liquid discharge head according to claim 1, further comprising a nozzle plate having a nozzle, wherein:
the first component includes a nozzle cover covering the nozzle plate;
the second component includes a base bonded to the nozzle cover;
the projection includes a portion of an outer edge of the nozzle cover which projects from a surrounding outer edge in the first direction; and
the groove includes a recess or a through hole facing the portion of the outer edge of the nozzle cover.

3. The liquid discharge head according to claim 1, further comprising a nozzle plate having a nozzle, wherein:
the first component includes laminated substrates including a plurality of substrates;
the second component includes a common channel substrate bonded to the laminated substrates, the common channel substrate having a common channel communicating with the nozzle of the nozzle plate;
the projection includes a portion of an outer edge of the laminated substrates which projects from a surrounding outer edge in the first direction; and
the groove includes a recess or a through hole facing the portion of the outer edge of the laminated substrates.

4. The liquid discharge head according to claim 1,
wherein the groove has a through hole having a thread.

5. The liquid discharge head according to claim 1,
wherein the groove is filled with an adhesive to bond the projection of the first component to the second component.

6. The liquid discharge head according to claim 1,
wherein the projection projects from an outer edge of the first component, and
the projection has an end face in the first direction as a cut surface.

7. The liquid discharge head according to claim 6,
wherein the groove faces the cut surface of the projection.

8. The liquid discharge head according to claim 1,
wherein the first component is laminated substrates including at least a first substrate and a second substrate laminated one on another,
the laminated substrates are bonded to the second component,
the first substrate has the projection,
the second substrate has another projection projecting in the first direction,
the groove faces the projection, and
an adhesive applied between the projection and the groove contacts a face of the projection facing the groove.

9. The liquid discharge head according to claim 8,
wherein said another projection is shifted from the projection in a fifth direction orthogonal to the first direction and the second direction.

10. The liquid discharge head according to claim 9,
wherein said another projection is closer to an outer side face of the second component than the projection in the fifth direction, the outer side face intersecting the front peripheral face and the side peripheral face.

11. The liquid discharge head according to claim 10,
wherein the laminated substrates include multiple projections including the projection and said another projection,
said another projection is closest to the outer side face of the second component among the multiple projections,
the second component further includes another groove facing said another projection, and
said another groove is deeper than the groove in the fourth direction.

12. The liquid discharge head according to claim 11,
wherein a face of said another projection facing said another groove and the second component are bonded to each other with the adhesive.

13. The liquid discharge head according to claim 11,
wherein said another groove extends to the outer side face of the second component in the fifth direction.

14. The liquid discharge head according to claim 11,
wherein a width of at least one of the groove or said another groove increase toward the outer side face of the second component in the fifth direction.

15. The liquid discharge head according to claim 9,
wherein the second component has an outer peripheral portion disposed on an outer side of the groove, and
the outer peripheral portion is higher than the laminated substrates.

16. The liquid discharge head according to claim 9,
wherein the laminated substrates include multiple projections including the projection and said another projection, and
a thinnest projection of the multiple projections having a thinnest thickness in the second direction is closest to an outer side face of the second component in the fifth direction among the multiple projections.

17. The liquid discharge head according to claim 9,
wherein the laminated substrates include multiple projections including the projection and said another projection, and
the projection is second closest to an outer side face of the second component in the fifth direction among the multiple projections.

18. The liquid discharge head according to claim 9,
wherein the laminated substrates include multiple projections including the projection and said another projection, and
at least one of the multiple projections is curved toward the second component.

19. The liquid discharge head according to claim 9,
wherein the second component has a common channel through which a liquid flows inside the second component,
the laminated substrates have through holes between the projection and the common channel in the first direction, and
the through holes penetrate the laminated substrates.

20. A liquid discharge apparatus comprising:
the liquid discharge head according to claim 1, to discharge a liquid to a medium; and
a conveyor to convey the medium to the liquid discharge head.
